(19) United States
(12) Patent Application Publication
(10) Pub. No.: US 2012/0178653 A1
(43) Pub. Date: Jul. 12, 2012

(54) Fraccing fluid with unique signature identifier and fluids and flow streams with identifier

(76) Inventor: Guy L. McClung, III, Rockport, TX (US)

(21) Appl. No.: 13/374,573

(22) Filed: Jan. 3, 2012

Related U.S. Application Data
(63) Continuation-in-part of application No. 13/373,283, filed on Nov. 9, 2011.
Application No. 13/373,283 is a continuation-in-part of application No. 13/317,588, filed on Oct. 21, 2011.
(60) Provisional application No. 61/458,444, filed on Nov. 22, 2010.
(60) Provisional application No. 61/455,886, filed on Oct. 28, 2010.
(60) Provisional application No. 61/456,307, filed on Nov. 4, 2010.
(60) Provisional application No. 61/459,484, filed on Dec. 13, 2010.
(60) Provisional application No. 61/519,054, filed on May 16, 2011.
(60) Provisional application No. 61/573,894, filed on Sep. 14, 2011.
(60) Provisional application No. 61/465,783, filed on Mar. 24, 2011.
(60) Provisional application No. 61/465,132, filed on Mar. 15, 2011.

(51) Int. Cl. C09K 8/60; C09K 8/80; B82Y 99/00

(52) U.S. Cl. 507/269; 507/200; 977/734; 977/742; 977/750; 977/752

(57) ABSTRACT

A thing or fluid, e.g., but not limited to a fraccing fluid, bodily fluid, or slurry with drill cuttings, the fluid with an identifier, the identifier including a unique identifying signature including nanomaterial. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### CROSS REFERENCE TO RELATED APPLICATIONS

This is a continuation-in-part of U.S. application Ser. No. 13/373,283 filed Nov. 9, 2011 which claims priority from U.S. Application Ser. No. 61/458,444 filed Nov. 22, 2011. This is a continuation-in-part of U.S. application Ser. No. 13/317,588 filed Oct. 21, 2011 which claims priority from U.S. Application Ser. Nos. 61/455,886 filed Oct. 28, 2010; 61/456,307 filed Nov. 4, 2010; and 61/459,484 filed Dec. 13, 2010. This is a continuation-in-part of U.S. application Ser. No. filed Dec. 16, 2011 entitled “Shale Shakers & Separators With Real Time Monitoring of Operation & Screens, Killing of Living Things n Fluids, and Heater Apparatus for Heating Fluids,” naming guy L. McClung, III as inventor. The present invention and application claim priority under the Patent Laws from pending U.S. application Ser. Nos. 61/519,054, May 16, 2011; 61/458,444, Nov. 22, 2010; 61/573,894, 14 Sep. 2011; 13/373,283 filed Nov. 9, 2011; 61/465,783 filed Mar. 24, 2011; 13/317,588 filed Oct. 21, 2011; 61/455,886, Oct. 28, 2010; 61/456,307 filed Nov. 4, 2010; 61/459,484 filed Dec. 13, 2010; and U.S. application Ser. No. filed Dec. 16, 2011 entitled “Shale Shakers & Separators With Real Time Monitoring of Operation & Screens, Killing of Living Things n Fluids, and Heater Apparatus for Heating Fluids,” naming guy L. McClung, III as inventor; and 61/465,132, Mar. 15, 2011. All patents and applications referred to here are incorporated fully herein for all purposes.

### BACKGROUND OF THE INVENTION

1. Field of the Invention

The present invention is directed to: fluids used in formation fracturing which has a unique signature identifier that is detectable to identify a particular fracturing or “fraccing” fluid at any point during a fraccing operation and at any point after the operation has been completed, including, but not limited to, at a location spaced-apart from or remote from the location of the introduction of the fraccing fluid into the earth; to methods for detecting such a fluid and its signature; and to methods for using such a fluid. The present invention is directed to fluids and flow streams used in wellbore operations which have a unique signature identifier that is detectable to identify a particular fluid or flow stream, to methods for detecting such a fluid or flow stream and its signature; and to methods for using or treating such a fluid or flow stream. The present invention is directed to a fluid or flow stream produced from a well which has a unique signature identifier that is detectable. The present invention is directed to fluids and flow streams which have a unique signature identifier that is detectable to identify a particular fluid, to methods for detecting such a fluid and its signature; and to methods for using or treating such a fluid.

2. Description of Related Art

There are a wide variety of known fracturing (“fraccing”) fluids, fluids used in wellbore operations, fluids produced from a well, proppants, and fluids used in numerous known methods and processes. There are a wide variety of known fluids used in a wide variety of wellbore operations.

A variety of nano RFID devices are known, see, e.g., U.S. patent application Ser. Nos. 12/501,909 filed Jul. 13, 2009, 12/498,689 filed Jul. 7, 2009; and 12/497,193 filed Jul. 2, 2009—all of which are incorporated fully herein for all purposes. A variety of micro-resonant devices are known, see, e.g., U.S. patent application Ser. No. 11/913,661 published Jan. 29, 2009, Pub. No. 2009/0027280 A1, incorporated fully herein for all purposes. A variety of nanodevices including nanorobots are known, see, e.g., U.S. patent application Ser. Nos. 12/604,310 filed Oct. 22, 2009 which is incorporated fully herein for all purposes. As defined below, for purposes of this invention and this application, McNano devices includes, inter alia, the devices disclosed referred to in, and disclosed in references cited in the five patent applications referred to above in this paragraph and in the two preceding paragraphs.

### BRIEF SUMMARY OF THE INVENTION

The present invention, in certain aspects, discloses fracturing fluids for use in earth formations, referred to as “fraccing” fluids, with detectable material therein that serves as a unique signature for a particular fluid. “Fraccing fluid” includes, in addition to the improvements disclosed herein of unique signature identifiers, any known material or materials used for fracturing a formation; including, but not limited to, those disclosed in U.S. Pat. Nos. 8,006,759; 7,950,455; 7,921,910; 6,725,926; 7,896,068; 8,082,994; 8,061,424; 7,931,087; 7,958,937; 7,946,340; 7,087,556; 6,767,867; 8,022,015; 8,006,760; 7,972,998; 7,784,541; 7,938,185; 7,255,169; 6,776,235; 8,006,755; 8,006,754; 7,954,548; 7,931,089; 7,407,010; 4,186,802; 7,398,826; 7,942,201 and in the references and patents cited in these patents. “Fluid” herein includes, by way of example and without limitation, liquids, vapors, gas, flowing streams of solids or flowing streams with solids therein, slurries, flowing material, and bodily fluids (intracorporeal or extracorporeal).

The present invention, in certain aspects, discloses fluids used in wellbore operations with detectable material therein that serves as a unique signature identifier for a particular fluid. Such fluids include, by way of example and without limitation, drilling fluid or “mud;” hydraulic fluids; power fluids; fraccing fluids; slurries with drilled cuttings therein; disposal fluids; injection fluids, fluids with proppants; streams or slurries with lost circulation material; lubricating fluids; slurries; non-hardened cements; and non-hardened epoxies. Identifiers present in a non-hardened or non-set material which is initially flowable or applyable can remain therein following hardening or setting to identify the hardened or set material.

The present invention, in certain aspects, discloses fluids produced from or flowing from a well with detectable material therein that serves as a unique signature for a particular fluid. Such fluids include, by way of example and without limitation, oil, gas, water, water with EWR (exothermic water reactant), disposal fluids, drilling fluids, injection fluids, flowback fluids, steam, and vapors.

The present invention, in certain aspects, discloses fluids including bodily fluids and/or fluids used in methods or operations with detectable material therein according to the present invention that serves as a unique signature for a particular fluid.

The detectable material useful in embodiments of the present invention include, by way of example and without limitation: material detectable with the eye; material detected with light or radiation; material of specific color or colors; material that fluoresces; material of specific electrical conductivity; material that is magnetically attractive; nanomaterial; mixtures or combinations of nanomaterial; material responsive to microwaves; acoustically responsive material; McNanos or McNano devices as disclosed in pending U.S. patent application Ser. Nos. 13/373,283 filed Nov. 9, 2011 and 61/458,444 filed Nov. 22, 2010—or a combination of two, three or more of individual types of detectable material or of different individual materials. Such detectable material includes, by way of example and not limitation, the detectable materials (trackers, taggants, markers, tracking material, tracers) disclosed in U.S. Pat. Nos. 8,006,755; 7,516,788; 6,725,926; 7,921,910; and 6,991,780; and methods and apparatuses for detecting detectable material according to the present invention includes the systems, devices, methods, and apparatuses disclosed in these patents. Such detectable materials include, by way of example and without limitation, nanomaterial, including, but not limited to, nanotubes, nanocomposites, nanohorns, functionalized nanotubes, metalized nanotubes, combinations of different nanomaterials, and combinations of different functionalized nanotubes and/or metalized nanotubes, e.g., functionalized nanotubes as disclosed in the U.S. patents and in the references and patents cited in these U.S. Pat. Nos. 7,858,691; 7,854,945; 8,062,702; 7,968,489; 6,905,667; 7,771,696; 7,459,137; 7,241,496; 6,203,814; 8,804,012; 8,058,364; and 7,976,816.

Detectable material includes, but is not limited to, a combination of one or two or more nanomaterials with one, two or more detectable non-nanomaterials. One particular detectable material according to the present invention is a nanomaterial with another detectable material that is not a nanomaterial. One particular detectable material according to the present invention is a nanomaterial with two other non-detectable materials that are not a nanomaterial. The nanomaterials are detectable by any suitable known method and/or apparatus. In one aspect, the nanomaterial is, or nanomaterials are, carbon nanotubes, functionalized or not. In one particular aspect, the nanomaterial is, or the nanomaterials are, McNano devices. In one aspect, the nanomaterial is, or nanomaterials are, fullerenes.

Nanomaterial that is detectable includes, by way of example and not limitation: nanomaterial included with, embedded in, coated with, integrated with, or connected to other material as well as stand-alone nanomaterial; nanotubes of desired largest dimension (“size”), diameter and/or length; and the nanomaterials disclosed in and discussed in the following U.S. patents and applications and in the patents and references cited therein—U.S. Pat. Nos. 8,084,505; 6,420,293; 7,581,645; 6,537,515; 7,105,596; 8,066,932; and application Ser. Nos. 11/589,305 filed Oct. 30, 2006; 12/243,165 filed Oct. 1, 2008;10/759,356 filed Jan. 16, 2004; 12/657,244 filed Jan. 16, 2010; 12/657,289 filed Jan. 16, 2010; and 12/657,288 filed Jan. 16, 2010.

In certain aspects, the detectable material is one of or a combination of: light reflective material; specific detectable chemical material; fluorescent material; colored material; electrically conductive material; material whose presence changes an electric filed or magnetic field; detectable living things; material (e.g., things, particles, items, objects, and/or solids) of known size or known largest dimension; material whose presence changes or responds to microwaves applied to a stream; very small devices or apparatuses, e.g., McNanos or McNano devices; and material that changes or responds to sound waves applied to a stream—and in one aspect, is nanomaterial with one, two or more of these. An appropriate detector is used for each of these detectable materials.

When multiple such materials are used, a detector or detectors are used to detect each type of detectable material.

A detector for detectable material used in embodiments of the present invention include any suitable known detector used for detecting a specific type or form of detectable material. A detector according to the present invention may be located: in a fluid which contains detectable material; in or on a device, apparatus, or piece of equipment; near such a fluid; and/or within or on a conduit or member through which the fluid flows.

The detectable material according to the present invention may be fed once, intermittently, periodically or continuously into a fluid. The detectable material may be introduced into fluid for a one-time test or for continuous testing. The detectable material may be introduced into a fluid upon the occurrence of an event; for example, and not by way of limitation, in response to an alarm or alert or upon the sensing of a parameter of the fluid or an operations parameter of a method or process. The detectable material may be introduced into any flow stream, pipe, transmission member, or conduit and into any piece of equipment, apparatus, or container, either into an input stream or an output stream, or into the interior of the equipment, etc. itself; and this applies to any thing in any system or apparatus disclosed herein, including, but not limited to, those shown in all the drawing figures hereof.

A control system with appropriate control apparatus may be used to control the introduction of detectable material into a fluid or into multiple fluids. Control may be manual or automatic, or both; on-site, remote, or both. Either the control system itself or a separate system may keep a record of type, time, location of introduction, and amount of detectable material added to fluid(s).

In certain embodiments, a control system is in communication (on-site, remote, or both) with a detector or detectors used for detecting detectable material in one stream or in multiple streams of a system. In certain aspects, in a system according to the present invention having a control system, the control system can be in communication with every operable mechanism, detector, and system associated with an operation, method, or process and can provide a variety of functions and operations in response to the detection of detected material in a stream flowing to, within, or from the system. In such embodiments, appropriate treatment systems, conduits, valves, pumps, apparatuses, material applicators, regulators, gauges, devices, and/or apparatuses are used in conjunction with the control system at appropriate locations in the system to effect the desired function or result.

Methods and processes using detectable material according to the present can be done in real time.

The present invention discloses, in certain aspects, monitoring of a NanoTag, McNanos, or Nanotransmitter used in a fluid or in a material, fluid or not, including solids and solids resulting from hardening or setting of a material. NanoTags, McNanos, and/or Nanotransmitters of a specific known size and/or which output a specific signal may be used. A fluid or material may be monitored for the presence of the NanoTags, McNanos, and/or NanoTransmitters.

The present invention provides, in certain aspects, a thing (e.g., fluid or material) with a NanoTag. “NanoTag” or “NanoTag identifier” includes: nanotransmitters; nano devices; nanomaterial (“nanomaterial” as defined below); nanomaterial in a known order; sequence or pattern on or in a thing; nanomaterial of a certain known type or types in or on a thing and/or in or on a thing in a certain order, sequence and/or pattern; and/or McNanos (“McNano” as defined below). In certain particular aspects, a NanoTag has a largest dimension or an overall outer diameter which is one of: less than about 1000 microns; less than 500 microns; less than 250 microns; less than 100 microns; less than 50 microns; less than 20 microns; less than 10 microns; less than 5; less than 1 micron; 900 nanometers; 500 nanometers; 250 nanometers; 200 nanometers; 100 nanometers; 50 nanometers; 25 nanometers; 10 nanometers; 5 nanometers; or between 1 and 5 nanometers. less than 500 nanometers; less than 250 nanometers; less than 100 nanometers;, less than 50 nanometers 25; less than 10 nanometers; and less than 5 nanometers.

In one aspect, a NanoTag is less than about 150 nanometers in each of width, length and thickness. Any detectable material according to the present invention may be of any possible size listed in this paragraph. Any detectable nanomaterial according to the present invention used in any embodiment hereof may be of any suitable size; e.g., but not limited to, any size listed in this paragraph from less than 1000 nanometers to 1 nanometer; e.g., but not limited to with a length of about 10 microns or a length between 10 to 100 microns.

In certain aspects, and which can be used in any embodiment of the present invention, the detectable material is carbon nanomaterial, e.g. but not limited to carbon nanotubes, and at least two different amounts of nanotubes are used, with each amount having nanotubes of a length of 100 microns or less and with the length of nanotubes in a first amount being different from the length of the nanotubes in the second amount; and, in one particular aspect of such amounts, the nanotubes of a first amount have a length between 10 and 30 microns and the nanotubes in a second amount have a length between 50 and 60 microns. Such nanotubes may be single walled nanotubes or multi-walled nanotubes, metallized nanotubes, functionalized with a desired functionalization, or not.

“McNanos” include: microdevices, nanodevices, nanorobots, micro-resonant devices (“MRDs”), nanotransmitters, and/or nano RFID devices (“nano RFIDs” or “nanotags”). Such very small devices are referred to herein collectively as “McNano” devices or “McNanos”. McNano devices are used, according to the present invention, in a variety of operations and with a variety of things, items and equipment—and in each use described below of a McNano, it is to be understood that in addition to any described use or function, the presence of the McNano serves as an identifier of the thing, item, fluid, or equipment that the McNano is used on or in, so it is one type of NanoTag identifier. In certain embodiments, at least one, one, or a plurality of such McNano device are used in equipment, systems, and operations in the oil and gas industries, e.g. in rig operations, well formation, well completion, well production, fluid processing, solids control, and testing methods and with equipment used in these methods. In certain aspects, the McNano device(s) are coated, sheathed, or layered with protective and/or strengthening material, e.g., but not limited to plastic, metal, polytetrafluoroethylene, and/or ballistic material to cope with a wellbore environment (e.g. but not limited to, environments of extreme temperature or environments of corrosive or caustic materials or fluids) in which a McNano device is used (and this can be true for an McNano device disclosed herein and any such device described below on any method according to the present invention).

McNano devices may have an overall outer diameter or largest dimension of less than about 1000 microns, and can be much smaller, e.g., less than 500, 250, 100, 50, 20, 10, 5, or 1 micron, or even on the nanometer scale, e.g., 500, 250, 200, 100, 50, 25, 10, or 5 nanometers. McNanos can be individual, standalone, monolithic devices, or can be made of a set of or a plurality of McNanos, e.g. nano-resonant devices, that are each on the nanoscale, e.g., in certain aspects, about 500 nanometers or less, e.g., less than 250, 100, 50, 25, 10, or 5 nanometers in size. McNanos can also be used which are between 10 and 100 microns in length.

“Nanomaterial” includes any known nanomaterial including, but not limited to, nanotubes, nanorods, nanowires, nanoparticles, nanostructures, nanohorns, nanofibers, nanocomposites, nanofabric, nanocylinders, nanotextiles, nanographene, nanographene ribbons, transformed nanomaterials, functionalized nanomaterial, metallized nanomaterial, nanofibrils, nanofabric, carbon nanomaterials, e.g., but not limited to, carbon nanotubes, and electrically conductive nanotubes, and including single walled nanotubes, multi-walled nanotubes, functionalized nanotubes and metallized nanotubes. For any specific fluid or material in any transmission, flow, method or process herein, the nanomaterial is sized for movement required for a specific transmission, flow, method or process; and, the nanomaterial is sized so that transmission, etc. is not inhibited or prevented.

In certain particular aspects, for example with fracturing fluids (or in additives for fraccing fluids and/or in a flowback stream of fraccing fluid), detectable material in the fluid (e.g., but not limited to, nanomaterial) can be sized: 1. so that the nanomaterial does not flow through pores or openings that the fluid will encounter; or, optionally, so that the nanomaterial will flow through such pores or openings.

Any detectable material herein can be in a time-release form; in a form so that it is released in response to a selected event; or in a form so that it is released upon contact with a certain substance, device or structure; including, but not limited to, in response to an event or condition or environment as described in U.S. Pat. No. 6,613,720 and in any patent or reference cited in this patent.

The present invention, in certain aspects, provides a thing, e.g., but not limited to, a fluid or material which has therein detectable material, a NanoTag, a McNano, nanomaterial, multiple such things, and/or a combination of any of these.

The present invention, in certain aspects, discloses materials with detectable material therein that serves as a unique signature identifier for a material.

It is within the scope of the present invention to provide fraccing fluids in which each amount of fraccing fluid used in a specific interval in an earth formation has a unique signature identifier.

It is within the scope of the present invention to provide fraccing fluids for a single well in which each amount of fraccing fluid introduced into the single well has the same unique signature identifier or each amount of fraccing fluid has a unique signature identifier that is specific to that single well.

It is within the scope of the present invention to provide water used in a fraccing operation with a unique signature identifier.

It is within the scope of the present invention to provide a fluid taken out of a well and/or a fraccing fluid exiting a well (e.g., but not limited to, flowback fluids) with a unique signature identifier.

The present invention provides a fraccing fluid with an identifier, the identifier including a unique signature identifier in combination with fraccing fluid material, the identifier including nanomaterial. Such a fraccing fluid may have one, or some of the following, in any possible combination: wherein the nanomaterial is one of nanotubes, functionalized nanotubes, carbon nanotubes, single walled nanotubes, multi-walled nanotubes, nanorods, nanohorns, McNano devices, nanorobots, nanotransmitters, nanotags, or a combination of any two or three of these; wherein the identifier includes nanomaterial and non-nanomaterial; wherein the nanomaterial includes at least two different nanomaterials; wherein the nanomaterial includes first carbon nanotubes and second carbon nanotubes, the first carbon nanotubes different from the second carbon nanotubes; wherein the difference between the first and second carbon nanotubes is one of size, functionalization, length, diameter, and wall-single walled or multi-walled; wherein the difference between the first and second carbon nanotubes is difference in size; wherein the difference in size is a difference in length; wherein the difference in length is a difference of at least 20%, at least 50%, at least 100%, or at least 200%; wherein the nanomaterial is functionalized carbon nanotubes; wherein the fraccing fluid is passable through a passageway in a thing and the nanomaterial is sized so that the nanomaterial is passable through the thing; wherein the thing is one of pipe, conduit, pump, valve, pipeline, tubing, flow controller, casing, float equipment, and filter; wherein the fraccing fluid is passable through an amount of earth and the nanomaterial is sized for passing through the amount of earth; wherein the fraccing fluid is introducible into an amount of earth and the nanomaterial is sized for passing through the amount of earth; wherein the fraccing fluid is flowback fluid coming from a wellbore following a fraccing operation and the identifier is added to the flowback fluid upon receipt from the wellbore of the flowback fluid; wherein the fraccing fluid is fluid for introduction through a wellbore into an earth formation and the identifier is added to the fraccing fluid before the fraccing fluid flows into the wellbore; wherein the fraccing fluid contains proppants and the proppants have an identifier, the identifier comprising a proppant identifier, the proppant identifier comprising a detectable material that serves as unique signature identifier for the proppants; wherein the proppant identifier is nanomaterial; and/or wherein the proppant identifier is nanomaterial in combination with non-nanomaterial.

The present invention discloses a fraccing fluid with an identifier, the identifier comprising a unique signature identifier in combination with fraccing fluid material, the identifier comprising at least a first identifier material and a second identifier material, the first identifier material different form the second identifier material. Such a fraccing fluid may have an identifier in which both the first and the second identifier materials are nanomaterials; or in which only one of the first and the second identifier materials is nanomaterial.

The present invention discloses a fluid with an identifier, the identifier including a unique signature identifier in combination with fluid material, the identifier including nanomaterial, e.g., any nanomaterial according to the present invention alone or with detectable non-nanomaterial.

The present invention discloses a fluid with an identifier, the identifier including a unique signature identifier in combination with fluid material, the identifier including at least a first identifier material and a second identifier material, the first identifier material different form the second identifier material. In such a fluid both the first and the second identifier materials are nanomaterials; or only one of the first and the second identifier materials is nanomaterial. Such a fluid may be a fraccing fluid, drilling fluid, drilling fluid with solids therein, drilling fluid with drilled cuttings therein, production fluid, oil, gas, vapor, injection fluid, steam, water, fluid with proppants, slurry, slurry with drilled cuttings, bodily fluid, blood, hydraulic fluid, power fluid, disposal fluid, fluid with lost circulation material, lubricating fluid, non-hardened cement, and non-hardened epoxies.

The present invention discloses a method for fracturing an earth formation, the method including: introducing a fraccing fluid into the earth formation; the fraccing fluid being any fraccing fluid according to the present invention, e.g. a fraccing fluid with an identifier, the identifier comprising a unique signature identifier in combination with fraccing fluid material, the identifier being nanomaterial. Such a method may include: further steps in which the fraccing fluid is introduced into the earth formation from a wellbore and at least a portion of the fraccing fluid flows through earth spaced-apart from the wellbore and said at least a portion of fraccing fluid does not return to the wellbore, said at least a portion of the fraccing fluid identifiable following passage through the earth spaced-apart from the wellbore using the identifier in the fraccing fluid.

The present invention discloses a proppant with an identifier, the identifier comprising a unique signature identifier in combination with proppant material, the identifier including nanomaterial. Such a proppant may have one or some, in any possible combination, of the following: wherein the nanomaterial is one of nanotubes, functionalized nanotubes, carbon nanotubes, single walled nanotubes, multi-walled nanotubes, nanorods, nanohorns, McNano devices, nanorobots, nanotransmitters, nanotags, or a combination of any two or three of these; wherein the identifier includes nanomaterial and non-nanomaterial, the nanomaterial includes at least two different nanomaterials, the nanomaterial includes first carbon nanotubes and second carbon nanotubes, the first carbon nanotubes different from the second carbon nanotubes, wherein the difference between the first and second carbon nanotubes is one of size, functionalization, length, diameter, and wall-single walled or multi-walled, wherein the difference between the first and second carbon nanotubes is difference in size, wherein the difference in size is a difference in length, wherein the difference in length is a difference of at least 20%, at least 50%, at least 100%, or at least 200%, wherein the nanomaterial is functionalized carbon nanotubes, wherein the proppant is in a fraccing fluid and the fraccing fluid is passable through a passageway in a thing and the nanomaterial is sized so that the nanomaterial is passable through the thing; and/or wherein the thing is one of pipe, conduit, pump, valve, pipeline, tubing, flow controller, casing, float equipment, and filter; wherein the proppant is in fraccing fluid and the fraccing fluid is passable through an amount of earth and the nanomaterial is sized for passing through the amount of earth; or wherein the fraccing fluid is introducible into an amount of earth and the nanomaterial is sized for passing through the amount of earth; or wherein the fraccing fluid is fluid for introduction through a wellbore into an earth formation and the identifier is added to the proppant before the fraccing fluid flows into the wellbore, wherein the identifier of the proppant is nanomaterial in combination with non-nanomaterial, or the identifier has at least a first identifier material and a second identifier material, the first identifier material different form the second identifier material; or wherein the identifier is first and second identifier materials and both the first and the second identifier materials are nanomaterials, and/or wherein only one of the first and the second identifier materials is nanomaterial; and such a proppant may include the material of any proppant disclosed in U.S. Pat. Nos. 8,075; 8,006,759; 7,976,949; 7,972,997; 7,919,183; 7,902,125; 7,845,409; 7,721,803; 7,708,069; 7,703,531; 7,402,338; 7,135,231; 7,132,389; 6,528,157; 4,564,459; 4,417,989; 4,493,875; 7,153,575; and in any other patent mentioned or listed herein.

The present invention discloses a fluid with drilling fluid and drill cuttings therein, either or both of the drilling fluid and the drill cuttings with an identifier, the identifier comprising a unique signature identifier, the identifier including nanomaterial or any identifier according to the present invention.

The present invention provides a method for fracturing an earth formation having a plurality of zones, the method including: introducing fraccing fluid into each of the zones of the earth formation; the fraccing fluid for each zone comprising a fraccing fluid with an identifier, the identifier comprising a unique signature identifier in combination with fraccing fluid material, the identifier comprising nanomaterial and/or any identifier herein (with or without nanomaterial), and the identifier for the fraccing fluid for each zone being unique for that zone and different from the identifiers for fraccing fluid for the other zones.

The present invention provides a method for identifying a fluid that has passed through a thing, the method including: flowing fluid through a thing, the fluid having an identifier, the identifier being a unique signature identifier, the identifier being any identifier according to the present invention and/or nanomaterial; and after the fluid has flowed through the thing, detecting the identifier in the fluid. In one embodiment of such a method the fluid is any fluid disclosed herein and the thing is one of pipe, conduit, earth, separator, filter, screen, pump, valve, cuttings processor, wellbore, and shale shaker.

The present invention discloses methods for adding a unique signature identifier to a fluid within a thing while the fluid is passing through the thing. Such an identifier then serves as proof that the fluid passed through the thing. The thing may be, for example, and not by way of limitation, a wellhead, a casing in a well, a tubing, coil tubing, a blowout preventer, a separation apparatus or system (e.g., centrifuge, cyclone, shale shaker, equipment, pump, valve, pipeline, top drive, vibratory separator, fraccing fluid system, hydrocyclone), bearing assembly, degassers, desilters, desanders, float collar, packer, drill bit, mud motor, conduit, pipe, service loop, and a service loop of a top drive.

The present invention provides detectable material used as a unique signature identifier that is chosen for strength, durability and/or survival upon encountering an environment and/or condition which could otherwise adversely affect, degrade, or destroy the identifier. Detectable material is available, for example, that can withstand conditions such as high or low temperatures, high or low pressures, excessive radiation (of all kinds), action of living things, impacts, shear forces, and tension. It is within the scope of the present invention to choose an identifier and detectable material that will survive in an anticipated environment and/or in encountering an anticipated condition or method operating parameter.

It is within the scope of the present invention in providing a unique signature identifier with detectable material that the amount of the detectable material be sufficient that the material be detectable. This includes, for moving fluid, an amount of material sufficient that to whatever point or location the fluid flows, sufficient detectable material is present so that the detectable material can be detected.

The amount of detectable material that is used with any thing or fluid according to the present depends on a variety of circumstances. The concentration of the detectable material is sufficient so that its presence will be detectable by the selected detection method and apparatus. In certain embodiments, it is desirable that the concentration of the detectable material not be substantially above that level (the level that allows detection) for a variety of reasons. For example, an overdose of detectable material could result in coagulation or clogging of flow members; and the use of more detectable material than needed can result in higher cost and, in some circumstances, could degrade a fluid or part of a flow member.

In certain aspects, the concentrations of detectable material is at least about 0.03% by weight of a thing or fluid as desired for convenient detection by conventional detection techniques and apparatuses, while in some situations concentrations in excess of 0.15%, and especially in excess of 0.2%, by weight are used. Thus, generally, it has been found in some embodiments that concentrations of from about 0.005 to about 0.5, and in one aspect about 0.01 to about 0.3, and also from about 0.03 to about 0.2, and also from about 0.03 to about 0.15, such as from about 0.05 to about 0.15, typically about 0.13, percent by weight, based on the weight of the fluid or thing plus detectable material, are useful.

In certain situations in which a combination of detectable materials is used, each type should be in a concentration sufficient to be detectable. In some situations, each type of detectable material is present in a concentration of at least about 0.005 percent, e.g. at least about 0.01 percent, and also at least about 0.02, and also at least about 0.03 percent by weight based on the weight of the fluid or thing plus the detectable material.

In certain aspects, the minimum concentration depends on the sensitivity of the detection apparatus or method and so it is possible that concentrations even lower than 0.01 percent may be used. For example, neutron activation analysis (NAA) is reported to be able to have detection limits of 1-5 ppm (or 0.0001-0.0005 wt %) for certain substances which allows detection (and concentration levels) in the range of 0.001 wt %.

Accordingly, the present invention includes features and advantages believed to enable it to advance identification technology. Characteristics and advantages of the present invention described above and additional features and benefits will be readily apparent to those skilled in the art upon consideration of the following detailed description of preferred embodiments and referring to the accompanying drawings.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain embodiments of the present invention to provide: New, useful unique, efficient, nonobvious fraccing materials; in certain aspects, such materials that are fraccing fluids with a unique signature identifier; New, useful, unique, efficient, nonobvious devices, systems and methods for monitoring operation and efficiency of a vibratory separator or shale shaker, in one aspect, in real time; and New, useful unique, efficient, nonobvious fluids; in certain aspects, such fluids with a unique signature identifier.

With any system according to the present invention, including but not limited to a system with vibratory apparatus or shale shakers, there may be a control system or control apparatus. In one aspect, the control system is for controlling vibratory apparatus and piezoelectric device(s). In one aspect, the control apparatus receives signals from the piezoelectric device(s) corresponding to vibration (e.g., of the screen apparatus, of the basket, and/or of the material introduction structure) and in response to said signals can change vibrations produced by the vibratory apparatus, e.g. to change vibration of the screen apparatus. In one aspect, the signals are indicative of status of the screening material. In one aspect, the signals indicate damage to the screening material and the control apparatus can change the vibration level or can turn off the vibratory apparatus after receipt of the signals.

In certain aspects, the electrically conductive material or electrical conductor of embodiments of the present invention is electrically conductive nanomaterial that includes any known nanomaterial which can conduct electricity including, but not limited to, electrically conductive nanotubes, nanorods, nanowires, nanoparticles, nanostructures, nanofibers, nanohorns, nanofabric, nanocylinders, nanotextiles, nanographene, nanographene ribbons, transformed nanomaterials, functionalized nanomaterial, metallized nanomaterial, and/or carbon nanomaterials, e.g., but not limited to, carbon nanotubes, and/or electrically conductive nanotubes including single walled nanotubes, multi-walled nanotubes, functionalized nanotubes and/or metallized nanotubes. In certain aspects, the detectable material, in any embodiment herein (including, but not limited to, the material DM, FIG. 1) is such nanomaterial, whether electrically conductive or not. It is also within the scope of the present invention for the detectable material to be, or to include: nanoreporters as disclosed in U.S. application Ser. Nos. 12/541,131 filed 13 Aug. 2009 and 12/158,953 filed 22 Dec. 2006; and/or probes as in U.S. Pat. No. 7,473,767; and, in one aspect such a nanoreporter and/or such a probe are used in detectable material in bodily fluids.

To one of skill in this art who has the benefits of this invention's teachings, other purposes will be appreciated from the descriptions herein when taken in conjunction with the drawings. The detail in these descriptions is not intended to thwart this patent's object to claim this invention no matter how others may later disguise it by variations in form, changes, or additions of further improvements.

It will be understood that the various embodiments of the present invention may include one, some, or any possible combination of the disclosed, described, and/or enumerated features, aspects, and/or improvements and/or technical advantages and/or elements in claims to this invention.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification.

These drawings illustrate embodiments preferred at the time of filing for this patent and are not to be used to improperly limit the scope of the invention which may have other equally effective or legally equivalent embodiments. In the appended figures, similar components and/or features may have the same numerical reference label.

FIG. 1 is a schematic view of a system according to the present invention.

FIG. 2 is a schematic view of a system according to the present invention.

FIG. 3A is a schematic view of a fraccing fluid according to the present invention in a container.

FIG. 3B is an enlargement of part of the fraccing fluid according to the present invention shown in FIG. 3A.

FIG. 4 is a schematic view of a system according to the present invention.

FIG. 5 is a schematic view of a system according to the present invention.

FIG. 6 is a schematic view of a system according to the present invention.

FIG. 7 is a schematic view of a system according to the present invention.

FIG. 8 is a schematic view of a system according to the present invention.

FIG. 9 is a schematic view of a thing according to the present invention.

FIG. 10 is a schematic view of a thing according to the present invention.

FIG. 11 is a schematic view of a system according to the present invention.

FIG. 12 is a schematic view of a system according to the present invention.

FIG. 13 is a schematic views of a system according to the present invention.

FIG. 14 is a schematic view of a system according to the present invention.

FIG. 15 is a schematic view of a system according to the present invention.

FIG. 16A is a schematic cross-section view of a proppant according to the present invention.

FIG. 16B is a schematic cross-section view of a proppant according to the present invention.

FIG. 16C is a schematic cross-section view of a proppant according to the present invention.

FIG. 16D is a schematic cross-section view of a proppant according to the present invention.

FIG. 16E is a schematic cross-section view of a proppant according to the present invention.

FIG. 16F is a schematic cross-section view of a proppant according to the present invention.

FIG. 17 is a schematic view of a system according to the present invention.

FIG. 18 is a schematic view of a system according to the present invention.

Certain embodiments of the invention are shown in the above-identified figures and described in detail below. Various aspects and features of embodiments of the invention are described below.

Any combination of aspects and/or features described below can be used except where such aspects and/or features are mutually exclusive.

It should be understood that the appended drawings and description herein are of certain embodiments and are not intended to limit the invention.

On the contrary, the intention is to cover all modifications, equivalents and alternatives falling within the spirit and scope of the invention as defined by the appended claims.

In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein the various portions (and headings), the terms “invention”, “present invention” and variations thereof mean one or more embodiments, and are not intended to mean the claimed invention of any particular embodiment.

So long as they are not mutually exclusive or contradictory any aspect or combination of aspects or features of any embodiment disclosed herein may be used in any other embodiment disclosed herein. The present invention includes a variety of aspects, which may be combined in different ways.

Further, this description should further be understood to support and encompass descriptions and claims of all the various embodiments, systems, techniques, methods, devices, and applications with any number of the disclosed elements, with each element alone, and also with any and all various possible permutations and combinations of all elements in this or any subsequent application.

Specific details are given in the following description to provide a thorough understanding of the embodiments. However, it will be understood by one of ordinary skill in the art that the embodiments may be practiced without these specific details.

Individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged.

A process may be terminated when its operations are completed, but could have additional steps not discussed or included in a figure. Furthermore, not all operations in any particularly described process may occur in all embodiments.

Embodiments of the invention may be implemented, at least in part, either manually or automatically. Manual or automatic implementations may be executed, or at least assisted, through the use of machines, hardware, software, firmware, middleware, microcode, hardware description languages, or any combination thereof.

When implemented in software, firmware, middleware or microcode, the program code or code segments to perform the necessary tasks may be stored in a machine readable medium. A processor(s) may perform the necessary tasks.

### DETAILED DESCRIPTION OF THE INVENTION

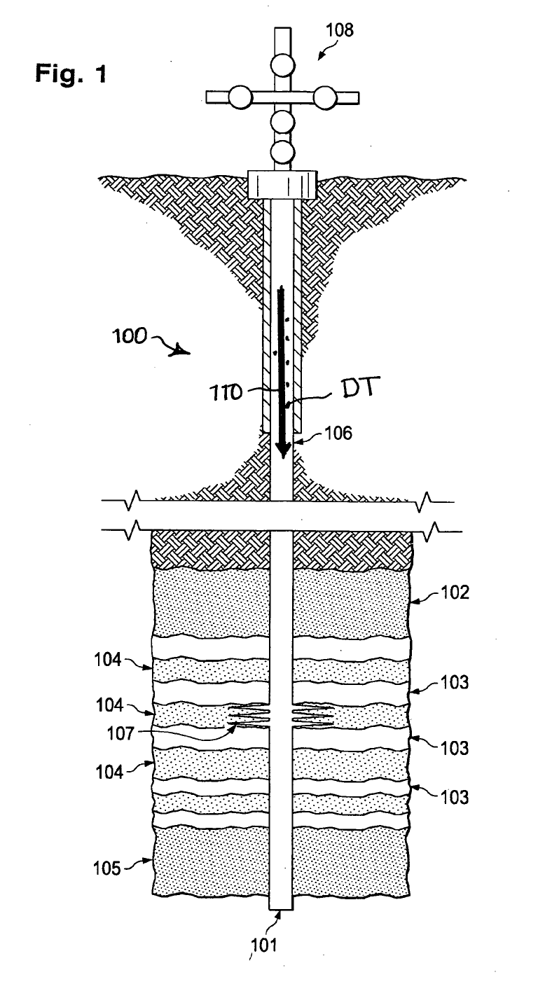

FIG. 1 shows a system 100 for fracturing a formation using fraccing fluids according to the present invention. A wellbore 101 is drilled through a multi-layered reservoir having lower effective stress (hydrocarbon-bearing) layers 103 and higher effective stress (non-hydrocarbon-bearing) layers 104. The number and distribution of these layers varies both within a reservoir and between different reservoirs. The multi-layered reservoir is bounded above and below by higher effective stress layers 102 and 105.

A fraccing treatment 110 according to the present invention with detectable material DT according to the present invention is pumped into an interval 107 that is to be fractured.

A conduit 106 is installed in the wellbore 101, through which the fraccing treatment 110 is pumped. This conduit 106 could be, but is not limited to, production casing, production tubing, coiled tubing or a “frac string” (a temporary conduit specifically designed for fracturing). Packers, or straddle packers may be used along with such conduits to isolate the casing openings at the desired fracture location. Methods for re-establishing pressure communication with interval 107 following cementing of the conduit 106 include, but are not limited to, perforating, sand jetting, or the opening of a fracturing valve (installed along with the conduit prior to cementing or along with a temporary “frac string”). An open-hole in the higher effective stress section that itself provides pressure communication with an impervious section is included as a method of “re-establishing pressure communication.”

The fraccing treatment 110 is pumped by pump apparatus (not shown), through the wellhead 108, down the conduit 106 and into the formation with pressure communication established with the interval 107.

In certain aspects, an increase in well-bore pressure, so as to cause the subterranean formation to fracture is achieved by pumping the fracturing treatment into the well-bore.

The fraccing treatment 110 can be any fraccing material (liquid, gas, vapor, with or without additives with or without proppants) according to the present invention with the detectable material DT therein (any detectable material according to the present invention, including, but not limited to, a combination of individual detectable materials).

In one aspect, such a fraccing treatment includes detectable material, a fracturing fluid, the fluid optionally including proppants and/or additives. Any type of fracturing fluid may be used, including, but not limited to, (1) oil or water based, (2) oil and water emulsions, (3) carbon dioxide based, or (4) a foamed fluid, e.g., containing nitrogen, hydrocarbon or carbon dioxide gas; and such a fracturing fluid may contain additives including, but not limited to, viscosifiers, cross-linkers, breakers, surfactants, buffers, friction reducers, fluid loss additives and foaming agents. Any type of proppant may be used, including, but not limited to, sand, ceramic, bauxite or plastic proppant. The proppant may be deployed by mixing it into the fracturing fluid during pumping.

In certain aspects, the fracturing fluid may include any “carrier” fluid and/or it is used ins very viscous form and may appear gelatinous at ambient temperature. The fracturing fluid typically has a viscosity from about 1 (0.001 MPasec.) to about 1,000 cp, (1 MPasec.) and more typically from 100 (0.1 MPasec.) to 700 cp (0.7 MPasec.) and most typically from 200 to 500 cp (0.2 to about 0.5 MPasec.).

The present invention provides, improvements to the subject matter of U.S. Pat. No. 7,938,185 (incorporated fully herein for all purposes). In certain aspects, the present invention provides methods for hydraulically fracturing subterranean formations penetrated from an earth surface by a cased well, at least one formation being a higher effective stress formation and at least one formation being a lower effective stress formation, the method including: a) establishing fluid communication between an inside of the cased well and the higher effective stress formation; b) injecting a fracturing fluid (any according to the present invention) into the cased well at a pressure sufficient to force the fracturing fluid into contact with the higher effective stress formation at a pressure sufficient to cause the higher effective stress formation to fracture; c) continuing injection of the fracturing fluid into the higher effective stress formation at a pressure and in an amount sufficient to cause the fracture in the higher effective stress formation to grow and extend into at least one lower effective stress formation; and, d) discontinuing the injection of the fracturing fluid.

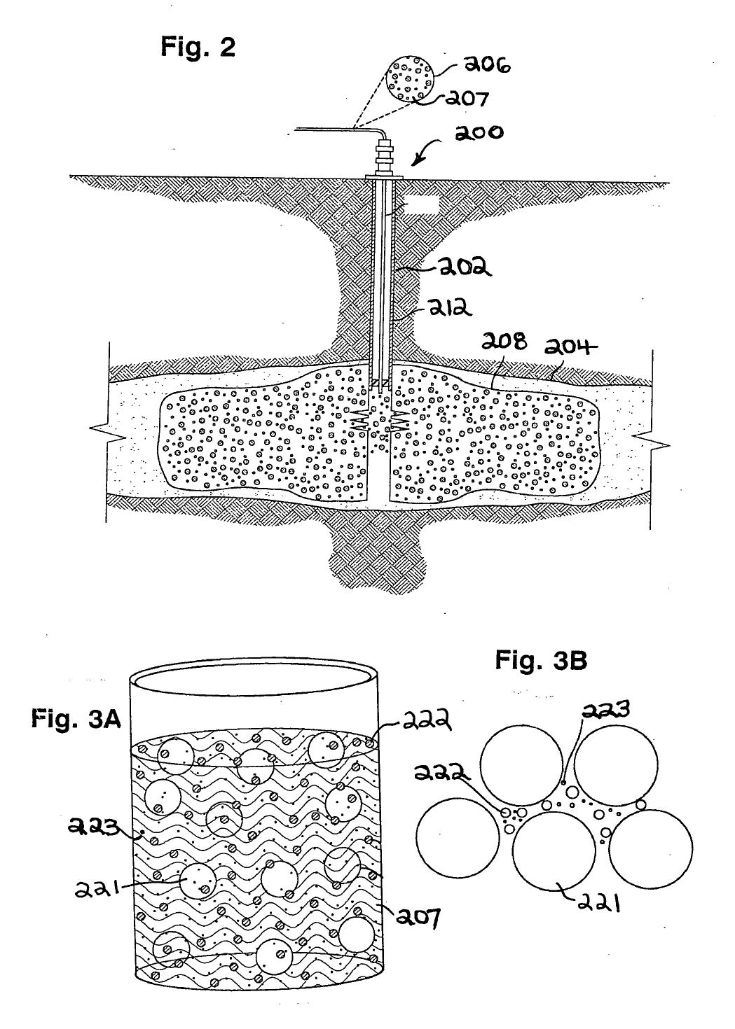

FIG. 2 shows a system 200 for fracturing a formation of interest 204 using a fracturing treatment according to the present invention. The system 200 includes a wellbore 202 in fluid communication with a formation of interest 104, which may be any formation wherein fluid communication between a wellbore and the formation is desirable, including a hydrocarbon-bearing formation, a water-bearing formation, a formation that accepts injected fluid for disposal, pressurization, or other purposes, or any other formation understood in the art.

The system 200 further includes a fracturing slurry 206 according to the present invention that includes a carrier fluid 207. The system 200 includes a pumping device 212 for pumping the fracturing slurry 206 to create a fracture 208 in the formation of interest 204 with the slurry 206.

The fracturing slurry 206 may be any fracturing material that has detectable material according to the present invention. In one particular aspect, as illustrated in FIGS. 3A and 3B, the fracturing slurry 206 has three different detectable materials 221, 222, and 223. Optionally one of these, any one, is deleted. Optionally, any two of these are deleted. The materials 221, 222, 223 are different and the differences may be any difference of any detectable material described herein. Materials in FIGS. 2-3B (and any materials depicted in all the drawings herein) are not shown to scale.

In one particular aspect, the material 223 is nanomaterial whose size (largest dimension) ranges between 1 and 10 nanometers; the material 222 is nanomaterial whose size ranges between 100 and 200 nanometers; the material 221 is nanomaterial whose size ranges between 500 and 700 nanometers; or the size ranges between 10 and 100 microns. The nanomaterial of each of the three may be the same or different.

In one particular aspect, the material 223 is nanomaterial whose size (largest dimension) ranges between 1 and 10 nanometers; the material 222 is nanomaterial whose size ranges between 20 and 50 nanometers; with size ranging between 10 and 100 microns; and the material 221 is nanomaterial whose size ranges between 100 and 150 nanometers. The nanomaterial of each of the three may be the same or different.

In one particular aspect, the material 223 is material whose size (largest dimension) ranges between 1 and 10 microns; the material 222 is nanomaterial whose size ranges between 20 and 50 microns; and the material 221 is nanomaterial whose size ranges between 100 and 150 microns. The material of each of the three may be the same or different.

In one particular aspect, the material 223 is material whose size (largest dimension) ranges between 100 and 200 microns; the material 222 is material whose size ranges between 300 and 500 microns; and the material 221 is material whose size ranges between 700 and 900 microns. The material of each of the three may be the same or different.

In one particular aspect, each of the materials 221-223 is a material whose size (largest dimension) prevents it from passing through the earth adjacent the fracture 208. In other aspects, the material 221 is of a size that prevents it from passing through earth adjacent the fracture 208; and the material 222 and 223 (or one of them only) is of a size such that it can pass through earth adjacent the fracture 208. In another aspect, each of the three materials are of a size such that it can pass through the earth adjacent the fracture. In any of these cases described in this paragraph, any one or any two of the materials may be deleted.

In one particular aspect, in which there are different earth materials, components, layers, stratas, or formations into which the fraccing slurry (or part of it) could flow, each of the materials 221-223 includes solids of a size (largest dimension) which can flow through one of the earth materials, components, layers, stratas or formation. In the event there are more than three earth materials, etc., then there can be, according to the present invention, separate detectable material in the fraccing slurry sized for passage through each such earth material, etc. (and this may be true for any fraccing fluid according to the present invention).

Any sized solid used in a fraccing treatment, material, or fluid according to the present invention may also be made of a detectable substance or chemical and/or with any other detectable property so that it is detectable in multiple ways.

It is within the scope of the present invention for the materials 221-223 to differ in any of the properties of detectable materials described herein; for example, and not by way of limitation, the material 221 may be of any desired size or substance and be colored yellow, the material 222 is metalized carbon nanotubes or carbon nanotubes functionalized with copper, and the material 223 is 300 micron size fiberglass fibers; or the material 221 may be carbon nanotubes of any desired size without functionalization, the material 222 is carbon nanotubes functionalized with a first functionalization, and the material 223 is carbon nanotubes with a second functionalization different from the first.

In one particular aspect, the fraccing slurry 206 is used for the slurry 106 of U.S. Pat. No. 7,784,541 (incorporated fully herein for all purposes) with or without the particulates mentioned in this patent. In one aspect, one or two of the particulates mentioned in the patent are deleted; and/or one, two, or all three of the particulates are detectable material according to the present invention.

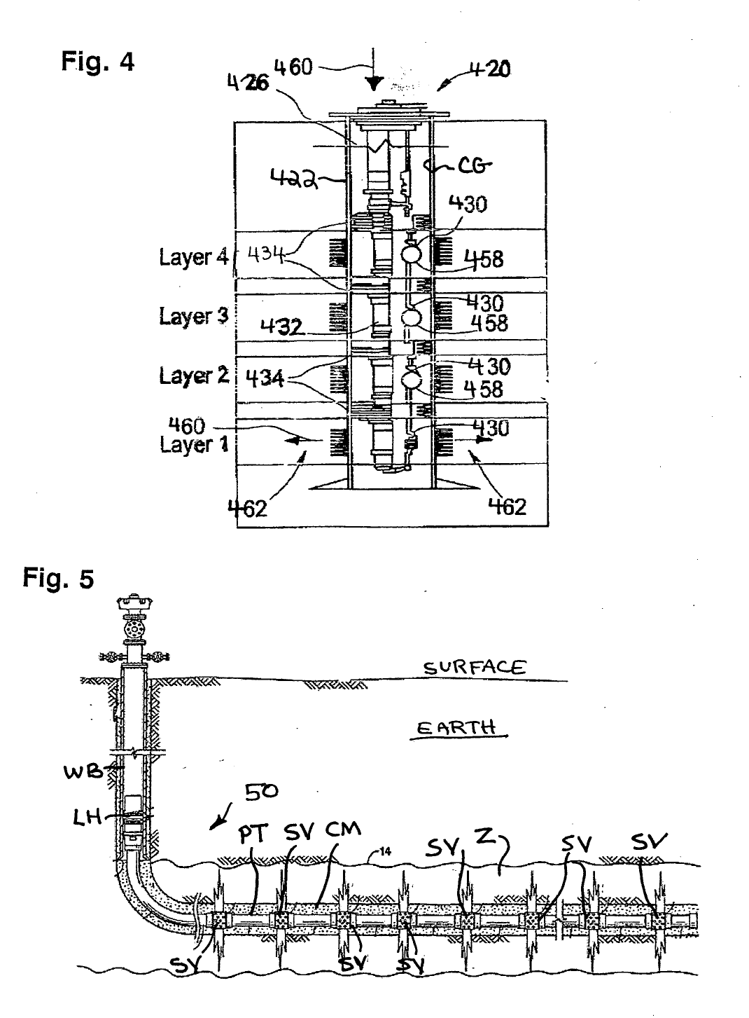

Referring generally to FIG. 4, a well system 420 according to the present invention is illustrated as deployed in a well 422 to facilitate individual fracturing of a plurality of formation layers 1-4 thereby enhancing hydrocarbon recovery. The well system 420 has a selective injection completion 426 for the controlled injection of fluid into individual, selected formation layers. The completion 426 can provide control over the injection flow, e.g. water injection flow, to individual formation layers via corresponding mandrels/flow control devices 430. A fraccing fluid 60 according to the present invention, with detectable material DR according to the present invention (any detectable material disclosed herein) including, but not limited to, e.g. a water-based fracturing fluid, is delivered down a tubing string 432. As shown in FIG. 4, in a first step, the fraccing fluid 460 is flowed outwardly through the lowermost mandrel 430 and into a lowermost formation zone (“layer 1”) to create desired fractures 462.

The selective injection completion 426 has isolation devices 434, e.g. packers. Optionally, the flow regulators 430 have dummy valves 458. Such a system, without fluid according to the present invention, is disclosed in U.S. Patent Application Publication No. 20110198088 (incorporated fully herein for all purposes). The tubing string 432 is deployed within a surrounding casing CG having perforations associated with each formation layer to enable flow of injection fluid from the tubing string 32, through the appropriate flow control device 430, through the corresponding perforations, and into the selected, surrounding formation layer.

Using the system 420 a fracturing process may involve pumping an injection fluid or fluids, e.g. water or another suitable fluid with detectable material according to the present invention. Separate fractures at separate levels, each with the same or with a different fracturing fluid according to the present invention can be performed in accordance with the selective string arrangement. The fracturing technique can thus be used to have different identifiers in each fluid and in each layer of the formation while avoiding communication between formations (assuming detectable material is properly sized to prevent inter-layer migration of identifiers).

The injection sequence can be repeated for each layer or group of layers of the subterranean region. The valves can be used to block flow into selected layers or formations while one layer 28 is fractured or otherwise stimulated.

After fracturing one layer, another layer is isolated, valves are operated to facilitate isolation and desired flow of fraccing fluid, and fraccing fluid is then introduced to that next layer being fractured. The fraccing fluid 460 can be the same or it can be a different fraccing fluid; and/or the fluid can have the same detectable material DR or it can have a different detectable material.

FIG. 5 shows a system 50 according to the present invention in a cemented open hole for the selective fraccing using fluid(s) according to the present invention at different locations along a production tubing. Such a system, but without the benefit of the teaching of the present invention and without a fluid or fluids according to the present invention with unique signature identifier(s), is disclosed in U.S. Pat. No. 7,926,571 (incorporated fully herein for all purposes).

In a producing zone Z, at preselected locations along a production tubing PT, the production tubing has spaced-apart sliding valves SV which can be selectively opened, and cement CM around the sliding valve dissolved. Then the formation may be fracced adjacent the opened sliding valve. By selectively opening different combinations of sliding valves, fraccing can occur in stages, optionally with more fraccing pressure and more fraccing fluid delivered deeper into the formation. The sliding valves can also be selectively closed to protect the production of the well.

The tubing PT extends from a liner hanger LH in a cased wellbore WB. Any known fluid that is pumped through tubing like the tubing PT can be a fluid according to the present invention with a unique signature identifier with detectable material according to the present invention, including, but not limited to, fraccing fluids, acidizing fluids or other fluids used in production that can be pumped into the well.

It is within the scope of the present invention for the same fluid to be pumped through each of the valves SV (eight shown, but any desirable number may be used), the fluid being a fluid according to the present invention, in one aspect, a fraccing fluid according to the present invention with a unique signature identifier with detectable material(s) according to the present invention; or different fluids according to the present invention can be pumped through different valves.

it is within the scope of the present invention for a wellbore with respect to which a fluid or fluids are used according to the present invention to be vertical, horizontal, or at any desired angle in the earth and this is not limited to the generally horizontal position of the part of the wellbore WB shown in FIG. 5 with the valves SV. Thus a desired fluid may be pumped to any part of a formation through a selected valve and different parts may have fluid pumped therein either in sequence or non-sequentially.

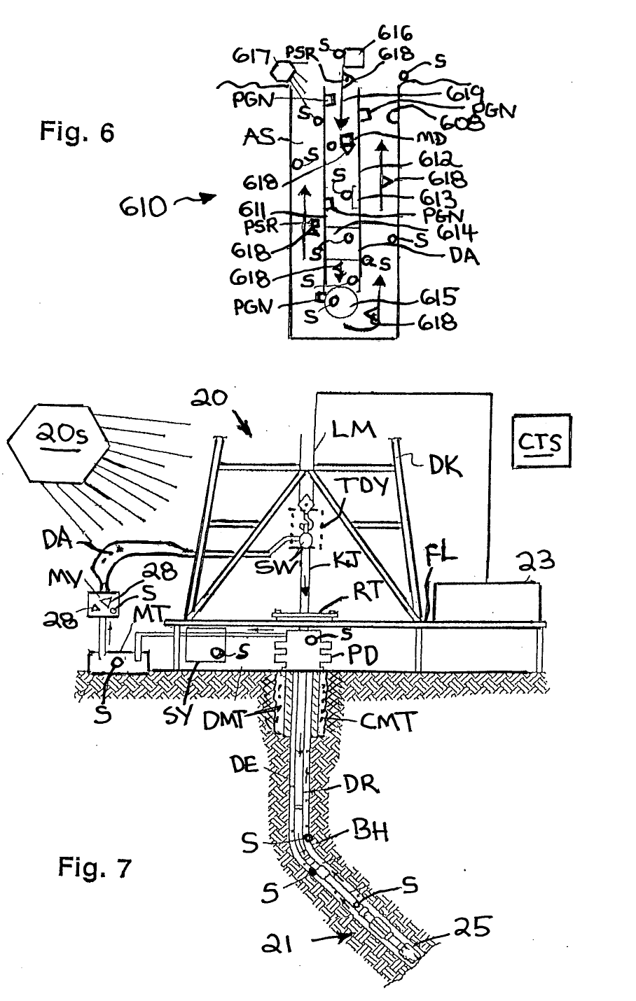

FIG. 6 illustrates schematically a method 610 according to the present invention in which McNano devices 618 (not shown to scale) in a fluid 619 (indicated by arrows pointing down, and pointing up) move within a wellbore 608 being formed in the earth E. The wellbore formation method may be like any known method in which a drilling apparatus DA forms a hole in the earth. The drilling apparatus DA may be a rotary drilling system, a top drive drilling system, a casing drilling system, a coil tubing drilling system, an air drilling system, a percussion drilling system, or a cable drilling system. The McNano devices 618 serve, inter alia, to provide a unique signature identifier for the fluid 619. As is true for any embodiment herein in which a McNano device is used, it is within the scope of this invention to substitute any other detectable material for the McNano device and/or to use other detectable material or materials in combination with the McNano device.

In one aspect, as shown, a drill bit 615 on the bottom of a tubular string 612 is rotated to form the wellbore 608. The fluid 619, as is well known, flows from the surface, through the tubular string 612, to and through the bit 615, and then upwardly in an annular space AS back to the surface. Optionally, the fluid 619 flows past wellbore apparatus 613. Optionally, the fluid 619 flows through the wellbore apparatus 614. In a casing drilling operation, the string 612 is a casing string. As is true for the McNanos in the other methods, systems and embodiments described herein, the McNano device 618 may be used as a NanoTag and/or it may be detectable material, including, but not limited to nanomaterial.

In certain aspects, the McNano devices are of such a size that they flow unimpeded through the tubular string 612 and through items or apparatuses they encounter at the surface and in the wellbore in equipment and conduits (including without limitation float collars, valves, packers, drill bits and mud motors) without damaging the items and apparatuses and without adversely affecting a function of the items or apparatuses or of the McNano devices.

Circles in FIG. 6 bearing a label “S” indicate that apparatuses S may be used in or on the items in the wellbore 8 and on the interior of the wellbore 8. An “apparatus S” includes detection apparatuses and/or devices for detecting detectable material; and include such apparatuses as described in U.S. patent application Ser. No. 13/373,283 filed Nov. 9, 2011 (which is incorporated fully herein for all purposes).

In certain aspects, apparatuses S are used to detect and/or to energize a McNano device so that it can be identified and/or communicated with; so that it can commence to perform a desired function; so that its presence can be determined; so that its movement can be determined; and/or so that a function it is to perform can be initiated or so that a function it is performing can be stopped; and such apparatuses (“apparatuses S”) can include any known apparatus used to energize, interrogate, control, and/or identify a Mcnano device; and in the embodiments described herein, an apparatus called an “apparatus S” is meant to encompass any of these apparatuses. Such apparatuses S may be located at any possible location, e.g., and without limitation, in a wellbore; in a conduit; and in or on thing, item, or piece of equipment. Similarly, a McNano device or devices may be in any fluid.

A control system 617 is in communication with an apparatus S and, in certain aspects, with a selected apparatus S, selected apparatuses S, or all such apparatuses. The system 617 can communicate with apparatuses S to obtain information from a McNano device and about parameters sensed by an apparatus S and/or to signal an apparatus S to begin to energize and/or interrogate a McNano device. The control system S may include or be used with the control functions of any known rig or drilling control system.

Fluid 619 may be provided by a fluid system 616 which may be any fluid system used in known drilling methods, including, but not limited to, a drilling fluid circulation system or a pneumatic system. It is within the scope of the present invention for the system 16 to introduce a McNano device (and/or other detectable material) into the fluid 619 or to have such device(s) and/or other detectable material introduced into the fluid 619 at any desired point within the wellbore 608 or at the surface.

As is true for any McNano device in any system or method herein, the McNano devices 618 may have or be associated with a power source or power supply PSR (two shown schematically and not to scale). Optionally, a power supply or power generator PGN (shown schematically and not to scale) may be used to provide power to the McNano devices 18 (and this can be done for any McNano device in any embodiment herein).

FIG. 7 shows a schematic diagram of a drilling system 20 according to the present invention which employs fluids according to the present invention and which has a drilling assembly 21 in a borehole BH for drilling a wellbore cased with casing CG (shown partially and schematically) cemented with cement CMT (shown partially). The drilling system 20 includes a derrick DK having a floor FL which supports a rotary table RT that is rotated by a prime mover whose motor (not shown) is controlled by a motor controller (not shown).

A drill string DR includes drill pipe DE extending downward from the rotary table through a pressure control device PD (e.g., but not limited to, one or more blowout preventers) into the borehole. Optionally, or in addition to the rotary system, a top drive drilling system TDY (shown in dotted line) can be used. Optionally, the cement CMT has detectable material DMT (any material according to the present invention).

A drill bit 25, attached to the drill string end, drill and disintegrates geological formations when it is rotated to drill the borehole. The drill string is coupled to a drawworks 23 via a kelly joint KJ, swivel SW and line LN through a pulley (not shown). This description is for a land rig, but the invention as disclosed herein is also equally applicable to any offshore drilling rigs or systems which use a fluid or fluids according to the present invention. Alternatives to conventional drilling rigs, such as coiled tubing rigs (shown schematically as CTS), can be used for drilling, and the invention disclosed herein is applicable to such systems.

Mud pump MU pumps drilling fluid (optionally with detectable material DA, any according to the present invention with any detectable material or materials according to the present invention, in addition to Mcnano devices) into the drill string via the kelly joint KJ through a blowout preventer apparatus PD and the drilling fluid is discharged at the bottom through an opening in the drill bit. The drilling fluid has one or a plurality of McNano devices 28 therein (not shown to scale) which are sized to flow from the mud pumps, through the wellbore, through items and apparatuses encountered in the wellbore and at the surface, and back to the mud pumps (and/or, optionally, other detectable material is used).

The drilling fluid circulates uphole through an annular space between the drill string and the borehole and returns to a mud tank MT via a solids control system SY. The solids control system may include shale shakers, centrifuges, and other known solids control equipment through which the McNano devices flow without being separated from the fluid and without adversely affecting what they flow through.

A control system 20s controls the apparatuses and equipment of the system 20 and is in communication with apparatuses S. The McNano device(s) 28 may be used like the McNano devices 18 of FIG. 6.

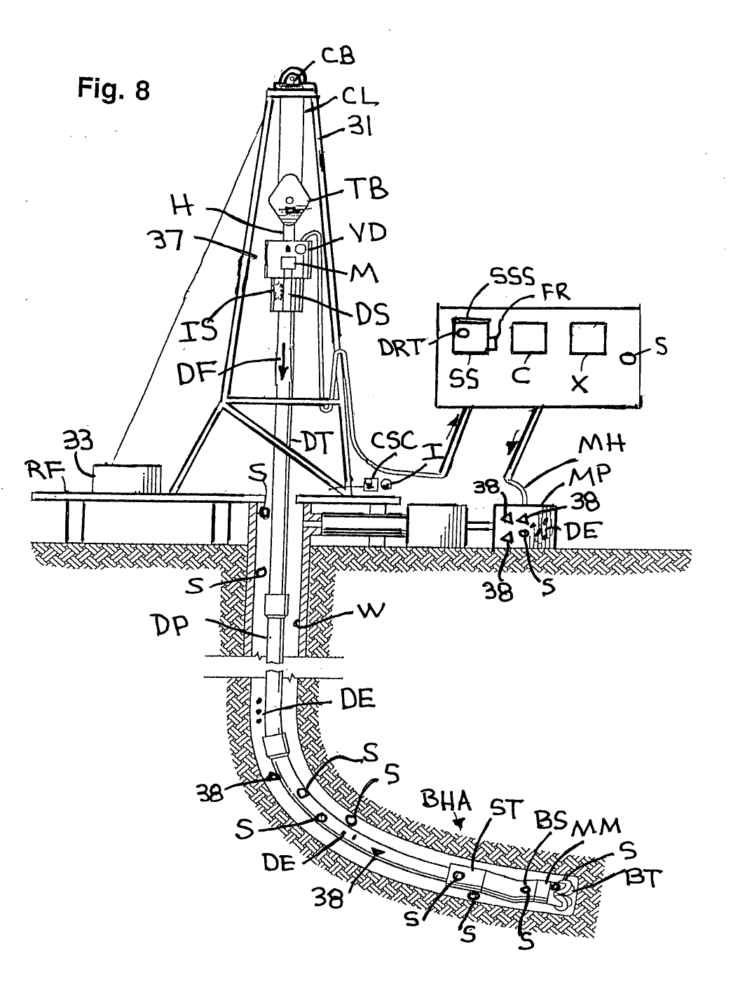

FIG. 8 shows a drilling rig 30 with fluids used according to the present invention. The rig is depicted as a land rig, but other rigs (e.g., offshore rigs, jack-up rigs, semisubmersibles, drill ships, and the like which use fluids according to the present invention) are within the scope of the present invention (and this is true for the other embodiments of rigs and wellbore operations described herein).

In conjunction with an operator interface, e.g. an interface I, a control system CSC controls certain operations of the rig. The rig 30 includes a derrick 31 that is supported on the ground above a rig floor RF. The rig 30 includes lifting gear, which includes a crown block CB mounted to the derrick 31 and a traveling block TB.

The crown block and the traveling block are interconnected by a cable CL that is driven by drawworks 33 to control the upward and downward movement of the traveling block. The traveling block carries a hook H from which is suspended a top drive system 37 which includes a variable frequency drive controller VD, a motor M (or motors) and a drive shaft DS. The top drive system 37 rotates a drillstring DT to which the drive shaft is connected in a wellbore W.

The drillstring is coupled to the top drive system through an instrumented sub IS which can include sensors that provide information, e.g., drillstring torque information. The drillstring may be any typical drillstring and, in one aspect, includes a plurality of interconnected sections of drill pipe DP a bottom hole assembly BHA, which includes appropriate stabilizers, drill collars, and/or an apparatus or device, in one aspect, a suite of measurement while drilling (MWD) instruments including a steering tool ST to provide bit face angle information. Optionally a bent sub BS is used with a downhole or mud motor MM and a bit BT, connected to the BHA.

Drilling fluid DF with McNano device(s) 38 (not shown to scale; and/or optionally with other detectable material DE) is delivered to the drillstring by mud pumps MP through a mud hose MH. During rotary drilling, the drillstring is rotated within the bore hole by the top drive system. Fluid from the well, McNano device(s) 38, (and detectable material if present) and cuttings produced as the bit drills into the earth are moved out of bore hole by mud pumps. The fluid from the well flows to solids control equipment SC which may include one or more shale shakers SS with one or more shale shaker screens SSS; one or more centrifuges C; and/or other fluid processing equipment X (e.g., but not limited to, degassers, desilters, desanders, and hydrocyclones).

The control system CS (like any herein) controls the apparatuses and equipment of the system 30 and is in communication with apparatuses S (like the apparatuses S, FIG. 1-II). The McNano device(s) 38 may be used like the McNano devices 18 of FIGS. 6 and 71.

In any of the systems herein, any device, conduit, pipe, apparatus or equipment may have detection apparatus for detecting detectable material in a fluid according to the present invention and any such device, etc. may have apparatus for introducing detectable material according to the present invention into a fluid flowing therethrough so that that fluid can then be identified as a fluid that passed through that device, etc. Examples of these devices etc., such a detector, and such a material introducer are the shale shakers SS, detector DRT, and material feeder FR.

It is within the scope of the present invention to use a amount or amounts of nanomaterial present in a thing. This presence which is ascertainable with any known method for detecting the presence of nanomaterial (which is in many instances the use of known material detection methods and/or instruments and/or apparatuses which can detect the type of material that is used for the nanomaterial) can then indicate that this is indeed the thing to be identified, inventoried, traced, used, checked, tested, replaced, shipped, transported, destroyed, etc.

In certain aspects, the actual nanomaterial is of a type of material that lends itself to detection with a particular detector; e.g., and not limited to, metal for metal detection, fluorescent for light detection, reflective for light detection, magnetically attractive for magnetic detection, radioactive for radiation detection, etc.

Any of the amounts of nanomaterial used as a NanoTag may be within a thing. For example, a thing according to the present invention has an amount of nanomaterial therein. Amounts of nanomaterial of different type or size may be used within a thing as a NanoTag.

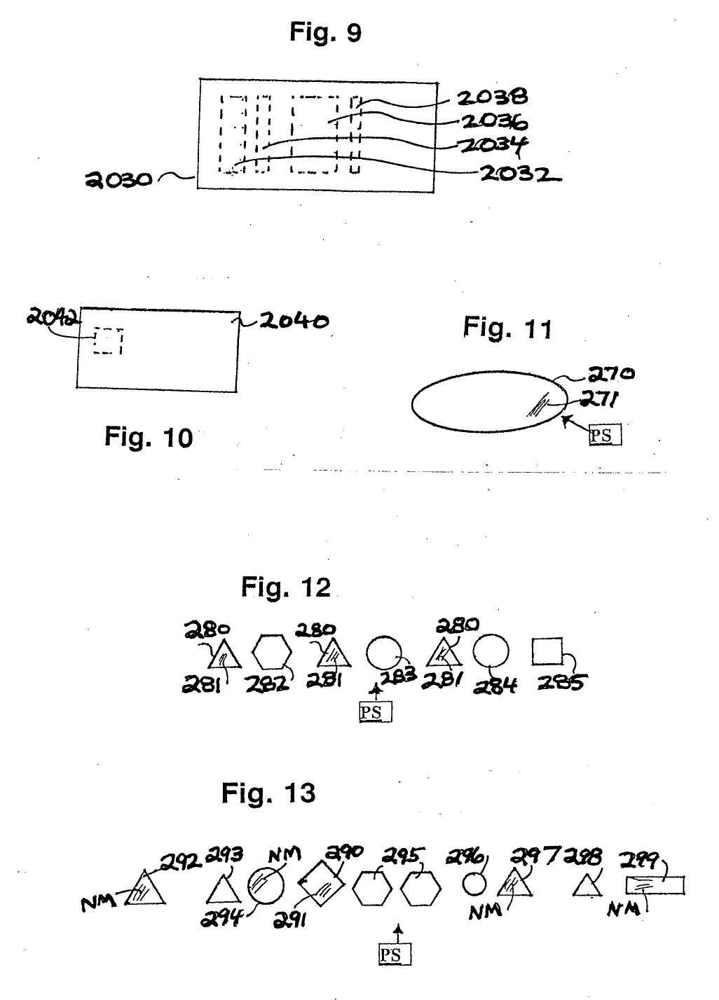

FIG. 9 illustrates that a thing may have amounts of nanomaterial of different shapes and/or of different widths within the thing. A thing 2030 has amounts of nanomaterial 2032, 2034, 2036, and 2038 therein. As with any amount of nanomaterial within a thing as a NanoTag, these amounts and their differences are detectable for identification, etc.

In one particular aspect an amount of nanomaterial used as a NanoTag is magnetically attractive material. As shown in FIG. 10, a thing 2040 has therein an amount 2042 of magnetically attractive nanomaterial. A magnet, magnet apparatus, or magnetic material detector may be used to detect and/or identify etc. the things with amounts of magnetically attractive material.

An amount or amounts of nanomaterial according to the present invention, including, but not limited to a NanoTag, used to identify, individuate, or to mark a thing (e.g., a fluid, liquid, vapor, slurry, flow of material) has specific parameters, dimensions, shape, aspects, location(s), relative location, qualities, and characteristic(s)—all collectively referred to herein as “properties.” Any known sensor, detector, analyzer, sensing system, inspection system, individuation system, or identification system used to sense or detect any such property can be used with an amount or amounts of nanomaterial used according to the present invention to identify, individuate, and/or to mark a thing.

Such systems—shown schematically in various figures and labeled PS (for “property system”) can be direct systems that actually come in contact with an amount or amounts of nanomaterial or non-contact and/or remote systems (passive or active) that do not contact the amount or amounts of nanoamterial; and a property system PS can detect, notice, and/or sense e.g.:
presence of nanomaterial;
nature of the nanomaterial (e.g., metal, plastic, paper, wood, glass, fiberglass, composite) including, but not limited to, specific substances, alloys, or elements (e.g., carbon, copper, bronze, tin, stainless steel, PTFE, lead, iron, steel, glass); or texture of the material;
relative location of amounts of nanomaterial, e.g., but not limited to, relative distance between amounts of nanomaterial, spacing between amounts of nanomaterial, and angular disposition of amounts of nanomaterial with respect to each other;
sensing systems that either use light and/or laser light to sense, or systems which are non-light based, e.g., but not limited to, systems that use sound, touch, feel, non-light spectrum electromagnetic energy or waves, and spectrographic or chemical sensing and/or analysis to detect the presence of an amount or amounts of nanomaterial in or on a thing, and/or the nature of the substances or elements that make up the amount or amount in or on a thing and/or location etc.

“Property system” includes, but is not limited to: spectrographic systems; X-ray systems; ultrasonic systems (e.g., but not limited to, those used to detect flaws, shapes, or thickness); laser systems; reading systems, e.g., those used in barcode scanning systems; magnetic detection systems; and guided wave systems; including, but not limited to, systems as disclosed or referred to in U.S. Pat. Nos. 7,171,854; 6,945,113; 6,748,808; 7,080,557; 6,862,099; 6,931,748; 6,772,636; 6,622,561; and 6,745,136—all said patents incorporated fully herein for all purposes; and “property system” includes apparatuses and devices, control systems, and a computer or computers associated and/or used with such systems, and hardware and software used with such computer(s).

In any embodiment disclosed herein and described above, any NanoTag, NanoTag Identifier or NanoDevice may be or may be replaced with an amount or amounts of nanomaterial in a thing for detection by a property system PS.

The property system PS may be used in a variety of ways. For example, to simply detect the presence of nanomaterial; to detect a specific amount of nanomaterial; to detect a specific type of nanomaterial(s); to detect an amount or amounts of nanomaterial that are unique to that type or class of thing; or to detect an amount or amounts of nanomaterial that indicate a unique thing. The thing may be any thing, fluid, vapor, slurry, flow of material, a living cell or mass of cells, an animal organ or bone or body part, a virus, a bacteria, a plant, an animal or a human being.

Any property system PS according to the present invention may include appropriate associated data and/or signal reception, processing, control storage and/or transmission apparatus and/or system or systems.

FIG. 11 shows a thing 270 with nanomaterial 271 therein. A Property System PS detects the presence of the nanomaterial 271 thereby identifying the thing 270. Optionally, the Property System PS analyses the nanomaterial 271 and determines what material makes up the nanomaterial 271; e.g., but not limited to, carbon.

FIG. 12 shows things 280 with nanomaterial 281 thereon or therein and other things 282, 283, 284, and 285. A Property System PS detects the presence of the nanomaterial 281 and thereby picks out the things 280 from the other things. Optionally, the Property System PS analyses the nanomaterial 281 and determines what material makes up the nanomaterial 281. Optionally, the Property System PS determines that the material that makes up the nanomaterial 281 is not present in any of the other things 282-284. Each of the things may be a fluid, vapor, slurry, liquid, or flow of material.

FIG. 13 shows a thing 290 (fluid, etc.) with nanomaterial 291 therein and other things 292, 293, 294, 295, 296, 297, 298, and 299. A Property System PS detects the presence of the nanomaterial 291, analyses it, and thereby picks out the thing 290 from the other things. Optionally, the Property System PS detects the other things and analyses nanomaterial NM in some of the other things in distinguishing the thing 290 from the other things.

The present invention provides: vibratory separators, systems using such separators, and methods of their use; in certain aspects to shale shakers; in certain particular aspects, to such systems with detection capability for detecting material flowing from such a separator or shaker which has detectable material therein, optionally with treatment of material; monitoring vibratory separator operation; monitoring and/or inspecting screening apparatus on a vibratory separator; discovering faults and/or tears in a screen apparatus; and, in certain particular aspects, to real-time monitoring of shake shaker operation and efficiency and/or to real-time inspection of shaker screens for wear, misplacement, and/or tearing of screening material.

The present invention, in certain aspects, discloses vibratory separators with: real time monitoring of operation and/or of screen(s); killing ability to kill living things in fluids flowing to and/or from a separator or shaker; and/or heating ability to heat such fluids. In certain aspects such a separator to shaker has detection apparatus for detecting material exiting from a vibratory separator. In certain particular aspects, the vibratory separator is a shale shaker used in wellbore operations. In certain aspects, detectable material is applied to one, two, or both streams from a separator or shaker; e.g., a cleaned stream and a stream with material that is separated from the cleaned stream.

The present invention, in certain aspects, discloses such a separator in which one or a plurality of detectors detect detectable material in one or in a plurality of streams flowing from a separator. In one aspect in which the separator is a shale shaker, one or a plurality of detectors detect detectable material in a stream from a top of screen apparatus, from a stream that has flowed through screen apparatus, or both.

In certain aspects, detectable material is introduced either into an initial stream fed to a separator or into a receiver that receives an initial stream. In another aspect, detectable material is fed separately to a component or components of a separator system. In one aspect in which the separator is a shale shaker, detectable material is applied to, introduced into, or fed to one, two, or all three of: initial feed stream itself; receptacle, tank, or “possum belly” into which an initial stream is introduced; and/or directly onto screening apparatus of the shale shaker (with a screen or screens essentially all at one general level or with a screen or screens at two, three, four or more distinct levels). Optionally, killing material is added into any of these structures or streams to kill living things therein.

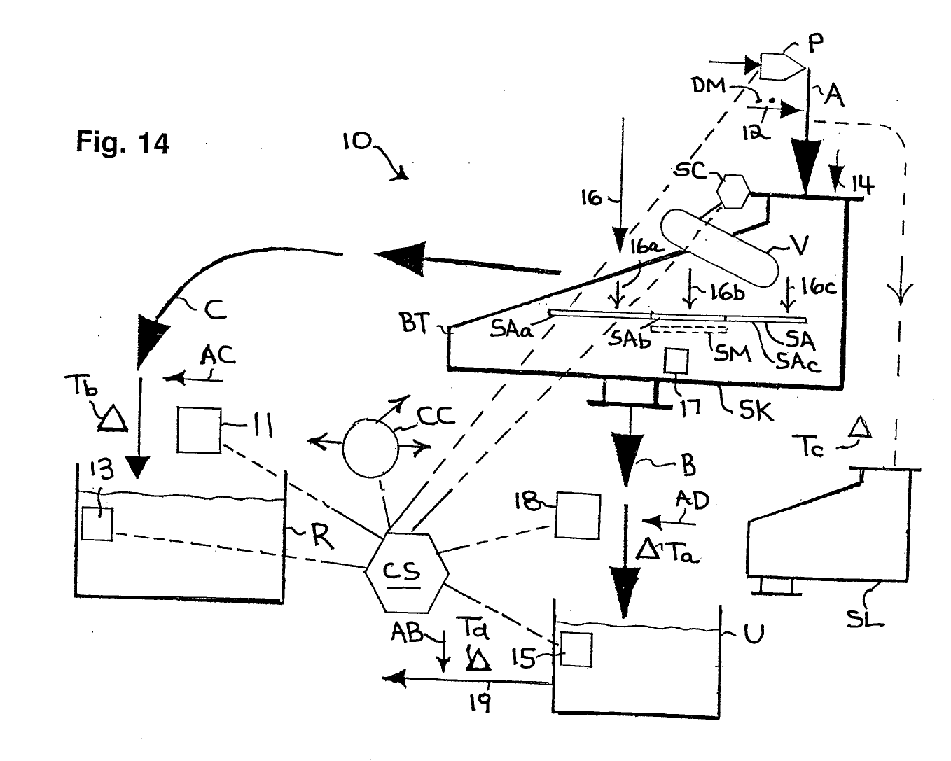

In certain aspects, detectable material of one kind is used. In other aspects, multiple detectable materials are used, either: all in one stream (multiple different materials fed into a single stream or multiple different materials fed into different streams); or different detectable materials are fed into different streams at different locations in an overall system. In one aspect, a first detectable material is fed into a bottom exit stream containing drilling fluid that has flowed through screening apparatus of a shale shaker and a second different detectable material is fed into a second stream containing cuttings, etc. which flows from the top of the screening apparatus. Such materials can act as an identifier for a stream into which they are introduced. Optionally, a third detectable material, different from the first and second, is fed into the initial feed stream to the shaker. In FIG. 14, the material DM may be any of these.

FIG. 14 shows a system 10 according to the present invention which has vibratory separator apparatus which, in this case includes a shale shaker SK which receives drilling fluid with solids therein pumped from a wellbore (not shown) by a pump system P in a stream A. The shale shaker SK has screen apparatus SA which includes multiple screens SAa, SAb and Sac. As shown, the screens are generally at a similar level; but, optionally, one or more screens may be at different levels, e.g., as shown by the screen SM shown in dotted line.

Vibratory apparatus V vibrates a structure, housing, or basket BT in which the screens are mounted. Material separated from the stream A (material that does not pass through the screens) flows off the top of the screens in a stream C to a pit or container R. Material flowing through the screens, including drilling fluid, flows down in a stream B to a receptacle or container U.

A control system SC controls the operation of the shaker SK (and it can be any suitable known shaker control system, including, but not limited to, known systems for automatic shaker operation). The control system SC can also control the pump system P. A control system CS controls the system 10 as described in detail below. Optionally, the control system CS also controls a conduit control system CC, described in detail below, and/or the control system SC.

Detectable material DM is fed in a stream 12 into the stream A. Optionally, or instead of the stream 12, detectable material is fed into the shaker SK in a stream 14 that mixes with the material in the stream A in the shaker before the material is fed onto the screens. Optionally, or instead of the stream 12, detectable material is fed in a stream 16 onto the screens. Optionally, a separate stream is fed to each of a plurality of screens; e.g., as shown streams 16a, 16b, and 16c are fed to screens SAa, SAb, and SAc, respectively. Optionally, such a feed stream is fed to screens at different levels in a separator or shaker; and, optionally, a different feed stream can be fed to each screen at each level.

A detector 18 detects detectable material in the stream B flowing down from the shaker SK. A detector 11 detects detectable material in the stream C flowing from the tops of the screens. Optionally, or in addition to the detector 18, a detector 17 in (as shown) or on the shaker SK detects detectable material in the fluid flowing down from the screens.

In one aspect, the stream B flows down into the tank U and a detector 15 in the tank U detects detectable material therein. The detector 15 may be used instead of or in conjunction with the detector 18 and/or the detector 17.

In one aspect, the stream C flows down into the pit R and a detector 13 in the pit R detects detectable material therein. The detector 13 may be used instead of or in conjunction with the detector 11.

Whether or not detectable material from a stream 12 (or a stream 14 or a stream 16) is in the stream B, additional detectable material is, optionally, added to the stream B in a stream AD.

This added detectable material can be the same as, or different from, the detectable material of the stream 12. Any “detectable material” herein may be one of or a combination of any of the detectable materials described herein.

Whether or not detectable material from a stream 12 (or a stream 14 or a stream 16) is in the stream C, additional detectable material is, optionally, added to the stream C in a stream AC. This added detectable material can be the same as, or different from, the detectable material of the stream 12.

Whether or not detectable material from a stream 12 (or a stream 14 or a stream 16) is in the stream 19 that conveys material from the tank U, additional detectable material is, optionally, added to the stream 19 in a stream AB. This added detectable material can be the same as, or different from, the detectable material of the stream 12.

Added detectable material, e.g., in a stream AB, AC, or AD, can be any detectable material disclosed herein used for any purpose or function disclosed herein and/or killing material, e.g., but not limited to biocide(s) (solids, liquid, solution) may be added to any of the streams. Killing material (as solids, liquid, solution or a combination of these), e.g., but not limited to a biocide or biocides, may be added to any of the streams 12, 14, 16, 16a, 16b, 16c, A, B, C and 19.

A combination of detectable material according to the present invention may be the same form of detectable material or it may be different forms of the same detectable material (e.g., and not by way of limitation, materials of different colors which are the same base material; materials of different size which are the same base material); or the different detectable materials may be different materials (e.g., and not by way of limitation, different chemically; material of a specific color with another material of a specific electrical conductivity; light reflective material of multi-micron size and carbon nanotubes; or pieces of plastic material combined with pieces of magnetically-attractive material).

It is within the scope of the present invention to treat a stream of the system 10 before or after a detector detects detectable material in the stream. For example, if detectable material (and/or living things) is detected in one of the streams B, C, or 19, following such detection the stream is treated by a treatment apparatus Ta, Tb, or Td. (whose various functions and treatments are disclosed in U.S. application Ser. No. filed Dec. 16, 2011 entitled “Shale Shakers & Separators With Real time Monitoring of Operation & Xcreens, Killing of Living Things In Fluids, and Heater Apparatus For Heating Fluids,” naming Guy L. McClung, III as inventor which is incorporated fully herein for all purposes).

The control system CS is in communication with the detectors 11, 13, 15, 17, and 18; with the control system SC; with the conduit control system CC; with the pump system P; and with the vibratory apparatus V. Via these connections, the control system CS can shut down the system 10 (e.g., in response to a signal from a detector that indicates screen damage, faulty screen mounting, or inadequate screen sealing) e.g., by stopping the pump system P or by activating the conduit control system CC to stop fluid flow to the system. The conduit control system CC controls all flow lines of the system 10 and includes appropriate and necessary piping, valves, connections, etc. for the various parts and streams of the system.

Optionally, upon shut down of flow to the shaker SK, the system CS has the stream A diverted to additional equipment or apparatus, e.g., to a tank or a shaker apparatus SL, as shown by the dotted line from the stream A to the shaker SL. An apparatus Tc can treat the flow stream to the shaker SL.

The control system CS can provide an alarm when any detector detects detectable material. Optionally, such an alarm is provided by a detector itself. With or without shutting down the system and with or without diverting any flow, the control system CS can activate one or all of the treatment apparatuses to treat a stream with which it is associated. In certain particular embodiments, with a separator or shaker with multiple separating elements or screens, the control system CS can shut down flow to a particular screen or screens so that operation can continue, e.g., when detection of detectable material indicates a damaged or worn screen, or poor screen mounting or sealing. Optionally, the control system CS can determine, from signals from detectors, that, although the shaker is not operating optimally, it is operating within an acceptable range; but a notification is provided that only a predicted amount of further acceptable operation is possible.

A control system CS may be used with any separator or shaker system according to the present invention.

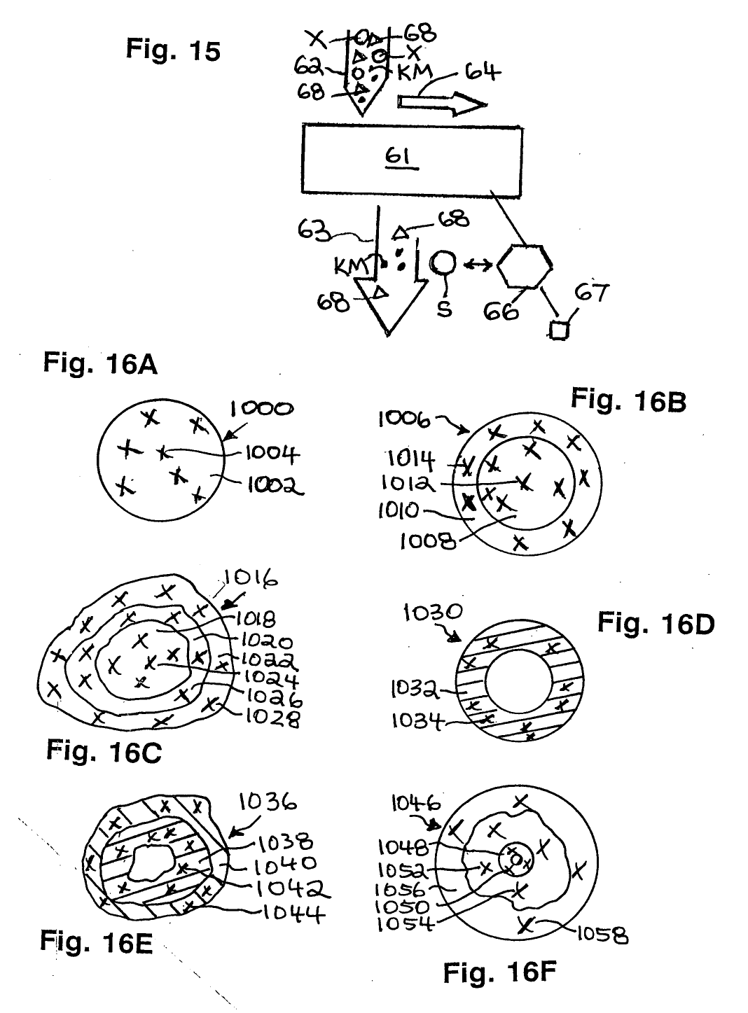

FIG. 15 illustrates a method according to the present invention for testing the efficiency of a separator 61 which separates solids X of a particular size from an input stream 62 that includes solids X. Detectable material 68 (any according to the present invention) is added to the flow 62. The detectable material may be of any desired size and, in one particular aspect is nanomaterial and, in another aspect is of the same size (e.g., of the same largest dimension) as the solids X so that, if the separator 61 is operating effectively, the detectable material 68 is/are separated from the flow 62 and is/are discharged with the separated solids X in a stream 64. However, if the separator 61, for whatever reason, allows the detectable material 68 to pass through and to be discharged in a stream 63, this provides an indication that the separator is not working as desired (the indication provided via monitoring electric current level and/or with ultraviolet light).

Alternatively, the passage of the detectable material indicates that the separator is working as desired. An apparatus S detects the presence of the detectable material 68 in the stream 63. Optionally killing material KM is added to the stream 62, the stream 63, or both.

The apparatus S can communicate with a control system 66 (on-site and/or remote) with information about the output stream and, optionally, the control system 66 can activate an alarm 67 and/or can alert and/or inactivate a system which controls the input stream 62 and can alter it or stop it. The separator 61 can be, e.g. and not by way of limitation, any known apparatus, filter, screen, shaker, vibratory separator, centrifuge, cyclone, solids control apparatus, or hydrocyclone and can include any filter media, screening material, filter, mesh, etc.

In one particular aspect, the apparatus S senses the level of electric current across the stream 63 when no detectable material 68 is present, providing and/or remembering this typical current level and then, following the introduction of the material 68 into the stream 62, the apparatus S continues to monitor the current level. A change in the current level from the typical level (the level before the introduction of the material 68) can indicate proper functioning, or something wrong with the separator, or that there wear or damage to such parts of the separator.

A treatment apparatus as any in FIG. 14 may be used with any stream shown in FIG. 15 (and also with any stream in any embodiment hereof).

The material 68 used in the system of FIG. 15 may be any detectable material disclosed herein and the apparatus S may be any detector disclosed herein (and this is true also for any stream of any embodiment hereof).

In certain aspects of the present invention, the thing or thing according to the present invention whose size is known and which is used in checking the efficiency and/or operation of an apparatus and/or monitoring and/or inspecting a filter, screen, etc. is any nanomaterial(s) disclosed herein.

Embodiments of the present invention include the use of unique signature identifiers for proppants used in fracturing operations to recover hydrocarbons from the earth. It is within the scope of the present invention to use any nanomaterial or nanomaterials according to the present invention in a proppant body and/or coating or encapsulation as disclosed in any of the following U.S. Pat. Nos. 7,073,581; 8,006,755; 7,407,010; 7,931,089; 8,006,759; 7,954,548; 7,950,455; 8,006,754; 8,006,755 7,255,169; 7,784,541; 7,972,998; 8,006,760; 8,061,424; 8,022,015; 7,931,087; 6,691,780; 7,921,010; 6,725,926; 7,516,788; 7,896,068; and 7,153,575 (all incorporated fully herein for all purposes)—and none of these patents, and none of any patent or application cited herein has any teaching or suggestion of using nanomaterial or nanomaterials for a unique signature identifier as taught by the present invention.

FIG. 16A illustrates a proppant 1000 according to the present invention which has a body 1002. The body 1002 may be any known proppant and/or made of any known proppant material or materials. The body 1002 contains detectable material 1004 (indicated by symbols “X”). The detectable material 1004 may be any detectable material disclosed herein. Neither the body 1002 nor the material 1004 is shown to scale. The detectable material 1004 may include a combination of multiple different detectable materials.

In one particular aspect, the material 1004 (as is true for the detectable material of the proppants of FIGS. 16B-16F) is a nanomaterial or a combination of different nanomaterials. In one particular aspect, the material 1004 (as is true for the detectable material of the proppants of FIGS. 16B-16F) is carbon nanotubes. In one specific aspect, the material 1004 (as is true for the detectable material of the proppants of FIGS. 16B-16F) is two (or three or more) different types and/or sizes of nanotubes. In one particular aspect, the material 1004 (as is true for the detectable material of the proppants of FIGS. 16B-16F) is two (or three or more) different types and/or sizes of carbon nanotubes.

Optionally, the material 1004 (as is true for the detectable material of the proppants of FIGS. 16B-16F) also strengthens the proppant 1000 (and an effective amount of the material 1004 is used so that the desired strengthening and level or amount of strengthening is achieved). In one aspect the material 1004 (as is true for the detectable material of the proppants of FIGS. 16B-16F) that strengthens the proppant is nanomaterial; and, in one particular aspect, carbon nanotubes.

Possible proppant materials for the body 1002 (and any proppant in FIGS. 16B-16F) include, but are not limited to, those disclosed in, those referred to in, and those cited in U.S. Pat. Nos. 7,073,581; 8,006,755; 7,407,010; 7,931,089; 8,006,759; 7,954,548; 7,950,455; 8,006,754; 8,006,755; 7,255,169; 7,784,541; 7,972,998; 8,006,760; 8,061,424; 8,022,015; 7,931,087; 6,691,780; 7,921,010; 6,725,926; 7,516,788; 7,896,068 (all incorporated fully herein for all purposes).

FIG. 16B illustrates a proppant 1006 according to the present invention which has a body 1008 within material 1010. The body 1008 may be any known proppant and/or made of any known proppant material or materials. The body 1008 contains detectable material 1012 (indicated by symbols “X”). The detectable material 1012 may be any detectable material disclosed herein. Neither the body 1008 nor the material 1012 (as is true for FIGS. 16B-16F) is shown to scale. The detectable material 1012 may include a combination of multiple different detectable materials.

The material 1010 may be any known material for encapsulating, coating, or enclosing a proppant, including, but not limited to, those disclosed in, referred to in, or in citations in any patent listed or mentioned herein. The material 1010 includes detectable material 1014 which may be any detectable material disclosed herein.

FIG. 16C shows a proppant 1016 according to the present invention to the present invention which has a body 1018 within material 1020 which is within material 1022. The body 1018 may be any known proppant and/or made of any known proppant material or materials. The body 1018 contains detectable material 1024 (indicated by symbols “X”). The detectable material 1024 may be any detectable material disclosed herein.

The material 1020 and the material 1022 may be any known material for encapsulating, coating, or enclosing a proppant. The material 1020 includes detectable material 1026 which may be any detectable material disclosed herein. The material 1022 includes detectable material 1028 which may be any detectable material disclosed herein.

Either material 1020 or material 1022 may be deleted.

FIG. 16D shows a proppant 1030 according to the present invention to the present invention which has a hollow body 1032 which may be made of any known proppant material or materials. The body 1032 contains detectable material 1034 (indicated by symbols “X”). The detectable material 1034 may be any detectable material disclosed herein.

FIG. 16E illustrates a proppant 1036 according to the present invention which has a hollow body 1038 within material 1040. The body 1038 may be any known proppant and/or made of any known proppant material or materials. The body 1038 contains detectable material 1042 (indicated by symbols “X”). The detectable material 1042 may be any detectable material disclosed herein.

The material 1040 may be any known material for encapsulating, coating, or enclosing a proppant, including, but not limited to, those disclosed in, referred to in, or in citations in the patents and references listed above for proppants. The material 1040 includes detectable material 1044 which may be any detectable material disclosed herein.

FIG. 16F shows a proppant 1046 according to the present invention to the present invention which has a hollow body 1048 within material 1052 which is within material 1056. The body 1048 may be any known proppant and/or made of any known proppant material or materials. The body 1048 contains detectable material 1050 (indicated by symbols “X”). The detectable material 1050 may be any detectable material disclosed herein.

The material 1052 and the material 1056 may be any known material for encapsulating, coating, or enclosing a proppant, including, but not limited to, those disclosed in, referred to in, or in citations in all patents and applications cited herein by serial number or patent number. The material 1052 includes detectable material 1054 which may be any detectable material disclosed herein. The material 1056 includes material 1058 which may be any detectable material disclosed herein. Either material 1052 or material 1056 may be deleted.

As is true for any nanomaterial disclosed herein for use in fluids and other things according to the present invention material used for encapsulation, coating, and/or enclosing a proppant and/or nanomaterial may be a release encapsulation, etc. that provides release of the nanomaterial, e.g. time release, release upon contacting a certain material, substance or chemical, or release upon the occurrence of an event. Any nanomaterial used in any embodiment hereof may be thus encapsulated, coated, and/or enclosed.

In any of the embodiments of FIGS. 16A-16F, the detectable material in a body may be deleted and, vice versa, in other embodiments, the detectable material in an encapsulation, etc. may be deleted.

The present invention provides compositions and methods for tracking the movement and transport of particulate solids during the production of hydrocarbons from a subterranean formation in which the tracking is facilitated by using detectable material according to the present invention. In one particular aspect, such tracking provides identification of flowback fluids with proppants therein. Such tracking and identification provides improvements to the subject matter of U.S. Pat. Nos. 6,691,780 and 6,725,926.

In one aspect the present invention provides a method for treating an earth formation including providing a particulate composition with particulate material and with a tracking material that includes detectable material according to the present invention; introducing the particulate composition into the earth formation; flowing back from the earth formation fluid with at least a portion of the particulate composition; and identifying, using the detectable material, particulate composition returned by detecting the detectable material—in one aspect, the detectable material being nanomaterial(s) according to the present invention. Such a method may employ any of the tracking materials and/or any particulate composition and/or any blending material disclosed in U.S. Pat. No. 6,691,780 or in U.S. Pat. No. 6,725,926.

In one aspect, the present invention provides a method of treating a subterranean formation having multiple zones penetrated by a well bore including: providing a plurality of particulate compositions with a particulate material and a tracking material, wherein the tracking material includes detectable material according to the present invention (in one aspect, the detectable material being nanomaterial or nanomaterials according to the present invention), wherein each particulate composition has a different tracking material (e.g., a different nanomaterial, e.g., different nanotubes, e.g., different carbon nanotubes); introducing a different particulate composition into each zone in the subterranean formation through a well bore; flowing fluid back from the subterranean formation and collecting at least a portion of any particulate compositions which flow back from the subterranean formation; and identifying particulate compositions returned by detecting the tracking material—in one aspect, the detectable material being nanomaterial(s) according to the present invention. Such a method may employ any of the tracking materials and/or any particulate composition and/or any blending material disclosed in U.S. Pat. No. 6,691,780 or in U.S. Pat. No. 6,725,926.

In one aspect, the present invention provides method of treating a subterranean formation having multiple zones penetrated by a well bore including: providing a plurality of treatment compositions with a tracking material, wherein the tracking material has any detectable material or materials according to the present invention (in one aspect, the detectable material being nanomaterial or nanomaterials according to the present invention); introducing a first treatment composition and a second treatment composition selected from the plurality of treatment compositions into respective ones of the multiple zones in the subterranean formation wherein the first treatment composition has a different tracking material than the second treatment composition; flowing fluid back from the subterranean formation and collecting at least a portion of any of the first and second treatment compositions that flows flow back from the subterranean formation; and detecting the tracking material in any collected portions of the first and second treatment compositions—in one aspect, the detectable material being nanomaterial(s) according to the present invention. Such a method may employ any of the tracking materials and/or any particulate composition and/or any blending material disclosed in U.S. Pat. No. 6,691,780 or in U.S. Pat. No. 6,725,926.

In one aspect, the present invention provides a method of treating a subterranean formation with multiple zones penetrated by a well bore, e.g., like the method of the receding paragraph wherein at least one of the treatment compositions includes a treatment fluid which is one of fracturing fluids, drilling fluids, disposal fluids and injection fluids.

The present invention provides, in certain aspects, a method of determining the source of particulate material returning from a subterranean formation having multiple fractures penetrated by a well bore including: placing a first proppant composition and a second proppant composition selected from a plurality of proppant compositions in respective fractures in the subterranean formation, wherein each of the plurality of proppant compositions includes particulate material associated with a tracking composition, wherein the tracking composition includes a detectable material or materials according to the present invention (in one aspect, the detectable material being nanomaterial or nanomaterials according to the present invention), and wherein the tracking composition associated with the particulate material of the first proppant composition is a different tracking material than the tracking composition associated with the particulate material of the second proppant composition; flowing fluid back from the subterranean formation and collecting at least a portion of any particulate material that flows back from the subterranean formation; and determining the source of particulate material that flows back from the subterranean formation by detecting the tracking composition associated with the particulate material—in one aspect, the detectable material being nanomaterial(s) according to the present invention. Such a method may employ any of the known tracking materials, tracers, markers, and taggants and/or any particulate composition and/or any blending material, e.g., as disclosed in U.S. Pat. No. 6,691,780 or in U.S. Pat. No. 6,725,926.

the present invention provides a proppant composition including detectable material embedded in a ceramic composition. Any suitable known ceramic composition may be used, including, but not limited to, those disclosed in U.S. Pat. No. 7,921,910 which is incorporated fully herein for all purposes. In certain aspects the amount of the detectable material is as stated above for amounts of detectable material in a fluid or thing. In other aspects, the detectable material is present in a concentration as disclosed in U.S. Pat. No. 7,921,910 or in the references listed or mentioned in this patent.

The detectable material, in certain aspects, is nanomaterial according to the present invention; and in particular aspects is a combination of at least two different nanomaterials according to the present invention; for example at least two different types of nanotubes or two different types of carbon nanotubes.

The ceramic composition proppant may be prepared by any suitable known method, including, but not limited to, pelletizing, tabletting, continuous spray atomization, spray fluidization, spray drying, compression and those methods disclosed in, referred to in, or in references cited in U.S. Pat. No. 7,921,910.

The present invention provides a method for tracking the backflow of proppants in a fractured subterranean formation into which a plurality of proppant composition particles including a detectable material or materials (any according to the present invention) uniformly distributed in a ceramic composition have been introduced, and analyzing a sample of the backflow by detecting for presence of the detectable material in the sample. In such a method, any of the tracer materials and/or ceramic materials may be used which are disclosed in, referred to in, or in references cited in U.S. Pat. No. 7,921,910.

The present invention provides a method for localizing the source of a particulate produced with a fluid through a wellbore, the method including the steps of: (A) providing a marking composition with at least one detectable material according to the present invention that is capable of binding with a particulate and has a detectable property distinguishable from the particulate (in one aspect, the nanomaterial according to the present invention is nanotubes, and, in one aspect, carbon nanotubes); (B) introducing the marking composition: (i) through a wellbore; and (ii) into contact with at least a portion of a subterranean formation penetrated by the wellbore; (C) obtaining fluid produced through the wellbore; and (D) analyzing a particulate produced with the produced fluid for the presence of the detectable material—in one aspect, the detectable material being nanomaterial(s) according to the present invention. Such a method may employ any of the marking compositions and/or any particulate material disclosed in, referred to in, in references cited in U.S. Pat. No. 7,516,788.

In certain aspects, the detectable material according to the present invention is a plurality of nanohorns, empty or with an interior material. In certain aspects, the nanohorns are made of any desirable material, and, on one particular aspect, they are carbon nanohorns. In one particular aspect, the nanohorns are carbon nanohorns with a substance within the carbon nanohorn and a plug that closes off the nanohorns interior and maintains the substance within the nanohorn, permanently or temporarily.

In certain aspects, the plug is degradable, destroyable, or disintegratable so that the substance within the nanohorn is exposed, exposed to other fluids or materials adjacent the nanohorn, or is permitted to exit the nanohorn.

Nanohorns may be used instead of, or in addition to, any nanomaterial or materials in any embodiment disclosed herein. In certain particular aspects, the nanohorns have a diameter of between 2 and 5 nanometers and aggregated structure of between 30 to 150 nanometers may be used—and such nanohorns can be used in any embodiment herein that uses nanohorns.

Any suitable known nanohorns may be used, including, but not limited to, those disclosed in U.S. Pat. No. 8,084,505 and in the references cited in this patent, both patent references and publication references; and any suitable known plug may be used, including those in this patent and the references therein.

The present invention discloses a product suitable for use in an oilfield environment including: a first component in liquid state; a first layer surrounding the first component, wherein the first layer is made of a protective material able to protect the first component from surrounding oilfield environment; a first susceptor, wherein the first susceptor is able to generate heat. Any or all of the first component, first susceptor, and first layer (and a second layer described below) may have detectable material or materials according to the present invention. In one aspect, the detectable material(s) is/are nanomaterial according to the present invention; in one aspect, nanotube; and in one aspect, carbon nanotubes or nanohorns. In one aspect, the first susceptor is able to interact with a magnetic field to generate the heat, as in U.S. Pat. No. 7,896,068 (and the materials of the various parts of the product may be any of those disclosed herein).

In one aspect, such a product also has a second layer surrounding the first layer. Either layer may be electrically conductive or non-conductive.

It is within the scope of the present invention to identify a flow stream with solids therein with unique signature identifiers according to the present invention. It is within the scope of the present invention to process such a stream so that unique signature identifiers according to the present invention remain in or on solids therein or solids that are no longer in the original flow stream following processing and/or transmission of the solids. In one particular aspect, such a flow stream contains drilled cuttings from a wellbore. Any detectable material according to the present invention may be used to identify such a flow stream and/or the solids from such a stream. Such a unique signature identifier can be added to such a stream at any point in a processing system and/or transmission system.

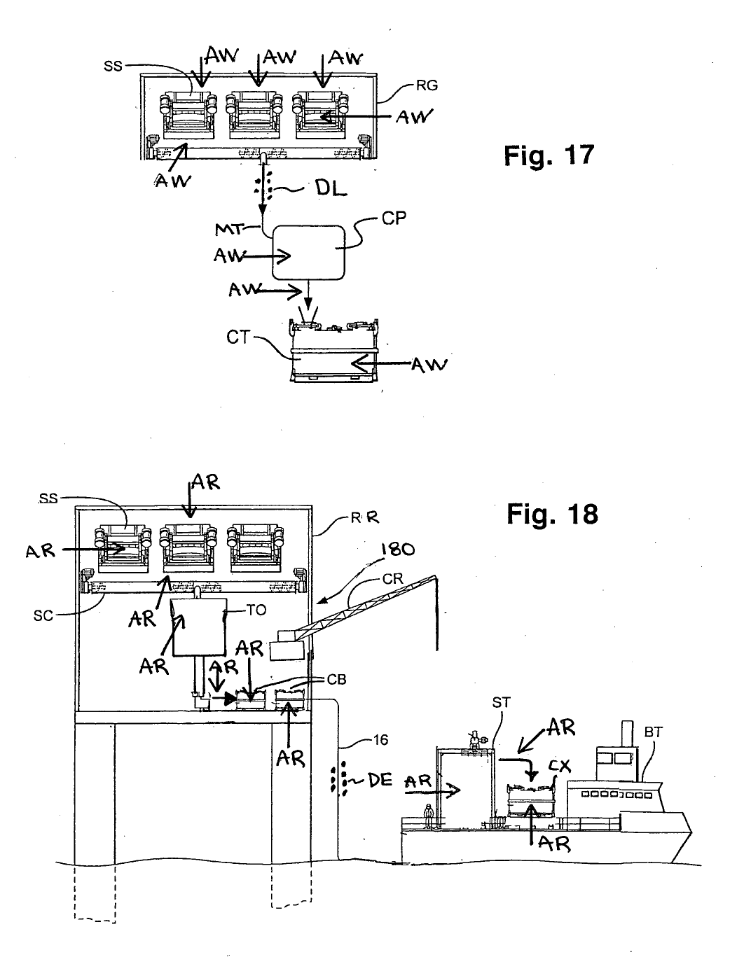

FIG. 17 shows a system 170 according to the present invention in which drilled cuttings from shale shakers SS or a rig RG (onshore or offshore) flow in a stream MT to cuttings processing apparatus CP (any known system. equipment or apparatus or processing cuttings) and from there to a storage container such as, e.g., the cuttings box CT (any suitable known cuttings box). Detectable material DL (any according to the present invention) is added to the stream MT to identify the cuttings material in the stream MT.

Optionally, or in addition to introduction into the stream MT, detectable material according to the present invention may be added at any point in the system 170 with exemplary locations indicated by the arrows AW.

In one particular aspect, the material DL is nanomaterial. In one particular aspect, the material DL is nanomaterial with another detectable material that is not nanomaterial. In one particular aspect, the detectable material DL is any two different detectable materials according to the present invention (as may be true for any detectable material in any embodiment herein).

FIG. 18 shows a system 180 according to the present invention for processing drilled cuttings from an offshore rig RR which has one or more (three shown) shale shakers SS mounted on the offshore rig RR. The shale shakers process drilling fluid having drilling solids, drilled cuttings, debris, etc. entrained therein. Separated solids and/or cuttings (with minimal liquid) exit shakers SS and are fed to a conveyor SC (or other cuttings movement apparatus) which moves the solids to a tank TO.

Solids from the tank TO are pumped to and through collection devices or containers; e.g. cuttings boxes CB. One such system will process 20 to 40 tons of material per hour (e.g., as in U.S. Pat. No. 6,988,567).

Solids, cuttings, and some drilling fluid, etc. flow continuously in the line 16 to storage tanks, e.g., cuttings box CX (or boxes), on a boat BT, e.g., via processing equipment ST.

The line 16 and/or tether/disconnect apparatus may be supported by a crane CR on the rig RR. The flow streams to and from the cuttings box or boxes in FIGS. 17 and 18 may be slurries as described in U.S. Pat. No. 6,988,567 and the amount of solids in these streams and the amount of fluid in these streams may also be as described in this patent.

In certain aspects, for the systems 170 and 180, drilled cuttings initially conveyed to the systems have 15% to 20% fluid by weight and drilled cuttings fed from cuttings processors have 1% to 3% fluid by weight.

The cuttings processors used in certain embodiments of the present invention receive material that includes drilled cuttings and recoverable drilling fluid.

The processor produces primary drilled cuttings whose drilling fluid component is much less by weight than the fluid-laden material in the initial feed. Fluid from any of the shale shakers of the systems 170 and 180 may also be identified by the addition of detectable material (any herein).

Detectable material DE (any according to the present invention) is added to the flowing material n the line 16 to identify the flow stream and the cuttings material therein. The detectable material DE may be any embodiment of the material DL in FIG. 17 or any detectable material used in the system of any drawing figure herein.

Optionally, or in addition to introduction into the line 16, detectable material according to the present invention may be added at any point in the system 180 with exemplary locations indicated by the arrows AR.

In one particular aspect, the material DE is nanomaterial. In one particular aspect, the material DE is nanomaterial with another detectable material that is not nanomaterial. In one particular aspect, the detectable material DE is any two different detectable materials according to the present invention.

In any embodiment herein, when two or more detectable materials are used to identify a particular fluid, stream, or material, the two detectable materials can be added together or they can be added separately, at the same addition location or point or at different addition locations or points.

It is within the scope of the present invention to identify a bodily fluid (e.g., blood, mucous, plasma, bile, urine, perspiration, phlegm, pus, expired air, feces) with any detectable material according to the present invention. The identification can be done by adding the detectable material intracorporeally or extracorporeally. In one particular aspect, the detectable material is nanomaterial. In one particular aspect, the detectable material is nanomaterial with another detectable material that is not nanomaterial. In one particular aspect, the detectable material DE is any two different detectable materials according to the present invention.

The present invention provides a thing with a unique signature identifier comprising nanomaterial, the nanomaterial included with and added to the thing for the identifying purpose of identifying the thing, the thing used for a thing purpose, the identifying purpose different from the thing purpose. Such a thing may be: a fluid, a fraccing fluid, a solid, a proppant, a bodily fluid, an amount of drill cuttings, in a flowing medium or not, drilling fluid, drilling fluid with solids therein, and drilling fluid with drilled cuttings therein. cement, hardened or not. In or with such a thing, the nanomaterial is one of: detectable material that is carbon nanomaterial, e.g. but not limited to carbon nanotubes; at least two different amounts of nanotubes; at least two different amounts of nanotubes with each amount having nanotubes of a length of 100 microns or less and with the length of nanotubes in a first amount being different from the length of the nanotubes in the second amount; nanotubes of a first amount with a length between 10 and 30 microns and the nanotubes of a second amount with a length between 50 and 60 microns; any such nanotubes being single walled nanotubes or multi-walled nanotubes, functionalized with a desired functionalization, or not; and, in other aspects, the nanomaterial may have the same purpose as, or contribute to the purpose of the thing or fluid.

The present invention provides a unique signature identifier including: two different detectable materials, whether or not they are nanomaterial; and/or nanomaterial(s) (any disclosed herein according to the present invention).

All patents and applications referred to herein are incorporated fully herein for all purposes.

What is claimed is:

1. A fraccing fluid with an identifier, the identifier comprising a unique signature identifier in combination with fraccing fluid material, the identifier comprising nanomaterial.

2. The fraccing fluid of claim 1 wherein the nanomaterial is one of nanotubes, functionalized nanotubes, carbon nanotubes, single walled nanotubes, multi-walled nanotubes, nanorods, nanohorns, McNano devices, nanorobots, nanotransmitters, nanotags, or a combination of any two or three of these.

3. The fraccing fluid of claim 1 wherein the identifier includes nanomaterial and non-nanomaterial.

4. The fraccing fluid of claim 1 wherein the nanomaterial includes at least two different nanomaterials.

5. The fraccing fluid of claim 1 wherein the nanomaterial includes first carbon nanotubes and second carbon nanotubes, the first carbon nanotubes different from the second carbon nanotubes.

6. The fraccing fluid of claim 5 wherein the difference between the first and second carbon nanotubes is one of size, functionalization, length, diameter, and wall-single walled or multi-walled.

7. The fraccing fluid of claim 5 wherein the difference between the first and second carbon nanotubes is difference in size.

8.-9. (canceled)

10. The fraccing fluid of claim 1 wherein the nanomaterial is functionalized carbon nanotubes.

11. The fraccing fluid of claim 1 wherein the fraccing fluid is passable through a passageway in a thing and the nanomaterial is sized so that the nanomaterial is passable through the thing.

12. The fraccing fluid of claim 11 wherein the thing is one of pipe, conduit, pump, valve, pipeline, tubing, flow controller, casing, float equipment, and filter.

13. The fraccing fluid of claim 1 wherein the fraccing fluid is passable through an amount of earth and the nanomaterial is sized for passing through the amount of earth.

14. The fraccing fluid of claim 1 wherein the fraccing fluid is introducible into an amount of earth and the nanomaterial is sized for passing through the amount of earth.

15. The fraccing fluid of claim 1 wherein the fraccing fluid is flowback fluid coming from a wellbore following a fraccing operation and the identifier is added to the flowback fluid upon receipt from the wellbore of the flowback fluid.

16. The fraccing fluid of claim 1 wherein the fraccing fluid is fluid for introduction through a wellbore into an earth formation and the identifier is added to the fraccing fluid before the fraccing fluid flows into the wellbore.

17. The fraccing fluid of claim 1 wherein the fraccing fluid contains proppants and the proppants have an identifier, the identifier comprising a proppant identifier, the proppant identifier comprising a detectable material that serves as unique signature identifier for the proppants.

18. The fraccing fluid of claim 17 wherein the proppant identifier is nanomaterial.

19. (canceled)

20. A fraccing fluid with an identifier, the identifier comprising a unique signature identifier in combination with fraccing fluid material, the identifier comprising at least a first identifier material and a second identifier material, the first identifier material different from the second identifier material.

21.-50. (canceled)

51. The fraccing fluid of claim 20 wherein at least one of the first and the second identifier materials is nanomaterial.

52. A method for fracturing an earth formation, the method comprising
introducing a fraccing fluid into the earth formation from a wellbore,
the fraccing fluid comprising an identifier, the identifier comprising a unique signature identifier, the identifier comprising nanomaterial,
at least a portion of the fraccing fluid flowing through earth spaced-apart from the wellbore and said at least a portion of fraccing fluid not returning to the wellbore,
identifying said at least a portion of the fraccing fluid identifiable following passage through the earth spaced-apart from the wellbore using the identifier in the fraccing fluid.

53. A proppant with an identifier, the identifier comprising a unique signature identifier, the identifier comprising nanomaterial.
